(19) United States
(12) Patent Application Publication
(10) Pub. No.: US 2003/0078960 A1
(43) Pub. Date: Apr. 24, 2003

(54) Architecture and process for creating software applications for multiple domains

(76) Inventors: Brian T. Murren, Clifton Park, NY (US); Richard B. Arthur, Ballston Spa, NY (US); Daniel L. Morrill, Clifton Park, NY (US)

Correspondence Address: LEE & HAYES PLLC, SUITE 500, 421 W RIVERSIDE, SPOKANE, WA, 99201

(21) Appl. No.: 09/845,737

(22) Filed: Apr. 30, 2001

(51) Int. Cl. G06F 15/16

(52) U.S. Cl. 709/203

(57) ABSTRACT

A multi-layer software architecture permits efficient and timely construction of processes and server-based software applications for many diverse domains, such as business-oriented domains like asset management, leasing and lending, inventory tracking, and so forth. The architecture is arranged into several hierarchical layers. Layers may be removed, modified, or updated without impacting other layers. This allows the architecture to adapt easily to many different problem domains, to support many different types of client devices, to accommodate many different users in different regions and cultures of the world, and to interface with many diverse resources.

### TECHNICAL FIELD

The present invention is directed to server-based software applications, and more particular to an architecture and method for creating such applications for multiple problem domains.

### BACKGROUND

Computer software applications are traditionally developed by writing source code for components of the application, including a main module and various other modules, as well as functions or subroutines that are invoked by the modules. The source code is typically developed specifically for the domain of one computer application. Domains pertain to a particular category or area of service that the application provides. Example domains include asset management, leasing and lending, insurance, financial management, inventory tracking, resale and repair management, and so forth. Since the source code is developed specifically for each domain, the components of one computer application developed specifically for one domain might not be reusable for another computer application under development for another domain. Although some utility components (e.g., sort routines) can be reused by different computer applications, they are typically very low-level components that are not related to the domain of the computer application. Because of the inability to reuse high-level components for multiple computer applications across diverse domains, the cost of developing a computer application can be quite high. In addition, because the components are new, their reliability is often unproven.

Many techniques have been developed to facilitate the reusability and reliability of software components. One well-known technique is object-oriented programming. Object-oriented programming allows a programmer to define a type of component, known as an “object”. Each type of object has a defined interface with a defined behavior. A programmer can develop a computer application to use the interfaces of objects that have been developed by other programmers to provide that behavior within the computer application. The behavior of an object is provided by methods (or member functions), and the data of an object is provided as attributes (or data members). Although object-oriented programming techniques have helped increase the reusability and reliability software components, it is still very expensive to develop a computer application even using these reusable components. Part of the expense is attributable to the need of a computer programmer to know and understand all the interfaces of the components in order to integrate the components into the desired computer application.

These problems in developing computer applications are exacerbated by the increase in size and functionality of many modern large-scale server applications. Applications that once could be executed only by very expensive mainframe or supercomputers can now be executed by relatively inexpensive desktop or server computers (or groups thereof). Large-scale applications that are distributed across multiple server computers and support a large amount of functionality are becoming increasingly common. However, due to their size and complexity, these applications typically require large teams of software designers to design, build, and test the applications.

The complexity and large-scale nature of such applications also makes subsequent modifications to the applications difficult. For example, modifying a user interface to support a new computing platform or display language can be very time-consuming, as all user interface aspects of the application are sought out, modified, and tested by the system designers to accommodate the new features. Conversely, any modifications to the underlying problem-solving model implemented in the application can affect the manner in which information is displayed to the user. Such modifications add significant time to the application development as the system designers review and test the problem-solving model to ensure that the new (or remaining) features are operational with the user interface.

It would thus be desirable to have a programming technique that would increase reusability and reliability of large and complex software components while still reducing the overall expense and time of developing computer applications.

### SUMMARY

A multi-layer software architecture permits efficient and timely construction of business processes and server-based software applications for many diverse domains, such as business-oriented domains like asset management, leasing and lending, inventory tracking, and so forth. The architecture is arranged into several hierarchical layers. An execution environment layer handles incoming requests from remote clients and selects the appropriate problem-solving logic to process the requests. The problem-solving logic is organized within a problem-solving logic layer that defines the application for a specific problem domain. For individual requests, the logic performs various series of tasks to process the requests and produce replies that will be returned to the clients.

A data abstraction layer facilitates retrieval of data from external resources and maps the data into a domain framework for the problem domain. A data coordination layer provides an interface for the logic layer to access the domain framework so that the logic layer can obtain the data from the resources when processing the requests. A presentation layer structures the replies generated by the logic layer into a desired appearance and encodes the replies using formats and communication protocols supported by different clients (e.g., Web browsers, wireless communications devices, personal digital assistants, etc.).

Any one of the layers may be removed, modified, or updated without impacting other layers. This allows the architecture to adapt easily to many different problem domains, to support many different types of client devices, to accommodate many different users in different regions and cultures of the world, and to interface with many diverse resources.

### BRIEF DESCRIPTION OF THE DRAWINGS

FIG. 1 illustrates a network system that implements a server application architecture that may be tailored to various domains.

FIG. 2 is a block diagram of the application architecture.

FIG. 3 is a flowchart illustrating a general operation of the application architecture when handling client requests.

FIG. 4 is a block diagram of an exemplary execution model configured as an asset catalog program and a controller to execute various interactions of the asset catalog program.

FIG. 5 is a flowchart of a process for executing the asset catalog program.

FIG. 6 is a block diagram of the program controller used in the execution model of FIG. 4.

FIG. 7 is a block diagram of a security policy enforcement module.

FIG. 8 illustrates an exemplary method of expressing security rules.

FIG. 9 is a flowchart illustrating the operation of the security policy enforcement module.

FIG. 10 is a block diagram of a presentation layer from the application architecture of FIG. 2.

FIG. 11 is a flowchart of a process for presenting a reply to a client device.

FIG. 12 illustrates a constraint hierarchy that can be configured to implement and enforce constraints to customize behavior of the application.

FIG. 13 is a flowchart of a process for conforming application operation to the constraints imposed by the constraint hierarchy of FIG. 12.

FIG. 14 illustrates an example form having multiple data input fields.

FIG. 15 illustrates an exemplary automatic form generation with input validation system.

FIG. 16 is a flowchart illustrating an exemplary process for automatically generating forms with input validation.

FIG. 17 illustrates an exemplary interaction that can be analyzed for identification of restrictions on input fields as well as for identification of fields themselves.

FIG. 18 is a flowchart illustrating an exemplary process for automatically identifying fields and field restrictions for forms.

FIG. 19 is a flowchart illustrating an exemplary process for automatically identifying field restrictions for forms.

FIG. 20 is a block diagram of a compilation and translation system to adapt application content authored for one locale to one or more other locales.

FIG. 21 is a flowchart of a process for adapting the content to multiple locales.

FIG. 22 illustrates a runtime mechanism that dynamically serves locale-specific content for a large-scale application with multinational users.

FIG. 23 is a flowchart of a process for dynamically producing locale-specific content.

The same reference numbers are used throughout the figures to reference like components and features.

### DETAILED DESCRIPTION

A software architecture specifies distinct layers or modules that interact with each other to facilitate efficient and timely construction of business processes and server applications for many diverse domains. Examples of possible domains include asset management, leasing and lending, insurance, financial management, asset repair, inventory tracking, other business-oriented domains, and so forth. The architecture implements a common infrastructure and problem-solving logic model using a domain framework. By partitioning the software into a hierarchy of layers, individual modules may be readily “swapped out” and replaced by other modules to effectively adapt the architecture to different domains.

With this architecture, developers are able to create different software applications very rapidly by leveraging the common infrastructure. New business models can be addressed, for example, by creating new domain frameworks that “plug” into the architecture. This allows developers to modify only a portion of the architecture to construct new applications, resulting in a fraction of the effort that would be needed to build entirely new applications if all elements of the application were to be constructed.

Exemplary System

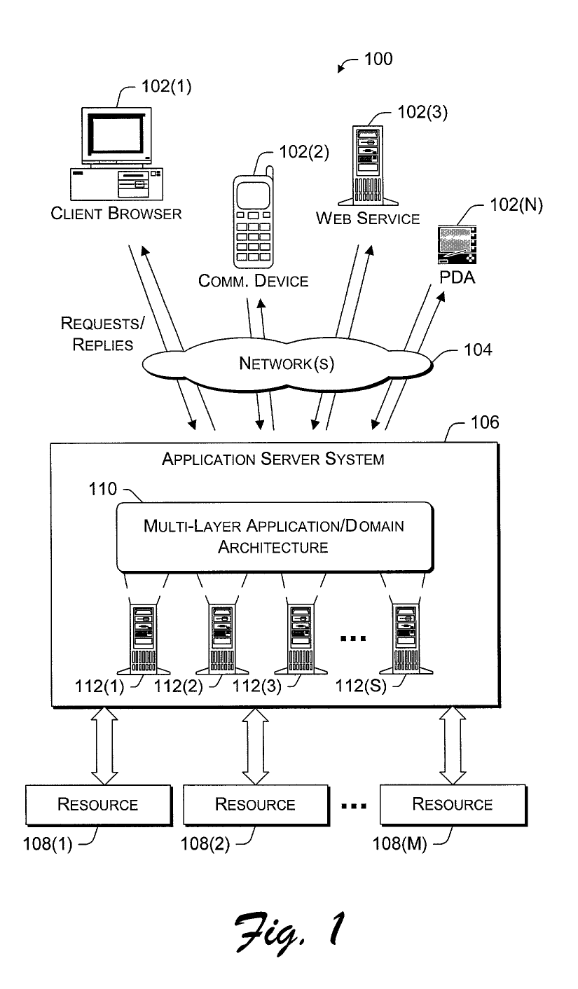

FIG. 1 shows a network system 100 in which the tiered software architecture may be implemented. The system 100 includes multiple clients 102(1), 102(2), 102(3), . . . , 102(N) that submit requests via one or more networks 104 to an application server system 106. Upon receiving the requests, the server system 106 processes the requests and returns replies to the clients 102 over the network(s) 104. In some situations, the server system 106 may access one or more resources 108(1), 108(2), . . . , 108(M) to assist in preparing the replies.

The clients 102 may be implemented in a number of ways, including as personal computers (e.g., desktop, laptop, palmtop, etc.), communications devices, personal digital assistants (PDAs), entertainment devices (e.g., Web-enabled televisions, gaming consoles, etc.), other servers, and so forth. The clients 102 submit their requests using a number of different formats and protocols, depending upon the type of client and the network 104 interfacing a client and the server 106.

The network 104 may be implemented by one or more different types of networks (e.g., Internet, local area network, wide area network, telephone, etc.), including wire-based technologies (e.g., telephone line, cable, etc.) and/or wireless technologies (e.g., RF, cellular, microwave, IR, wireless personal area network, etc.). The network 104 can be configured to support any number of different protocols, including HTTP (HyperText Transport Protocol), TCP/IP (Transmission Control Protocol/Internet Protocol), WAP (Wireless Application Protocol), and so on.

The server system 106 implements a multi-layer software architecture 110 that is tailored to various problem domains, such as asset management domains, financial domains, asset lending domains, insurance domains, and so forth. The multi-layer architecture 110 resides and executes on one or more computers, as represented by server computers 112(1), 112(2), 112(3), . . . 112(S). The tiered architecture 110 may be adapted to handle many different types of client devices 102, as well as new types as they become available. Additionally, the architecture 110 may be readily configured to accommodate new or different resources 108.

The server computers 112 are configured as general computing devices having processing units, one or more types of memory (e.g., RAM, ROM, disk, RAID storage, etc.), input and output devices, and a busing architecture to interconnect the components. As one possible implementation, the servers 112 may be interconnected via other internal networks to form clusters or a server farm, wherein different sets of servers support different layers or modules of the architecture 110. The servers may or may not reside within a similar location, with the software being distributed across the various machines. Various layers of the architecture 110 may be executed on one or more servers. As an alternative implementation, the architecture 110 may be implemented on single computer, such as a mainframe computer or a powerful server computer, rather than the multiple servers as illustrated.

The resources 108 are representative of any number of different types of resources. Examples of resources include databases, websites, legacy financial systems, electronic trading networks, auction sites, and so forth. The resources 108 may reside with the server system 106, or be located remotely. Access to the resources may be supported by any number of different technologies, networks, protocols, and the like.

General Architecture

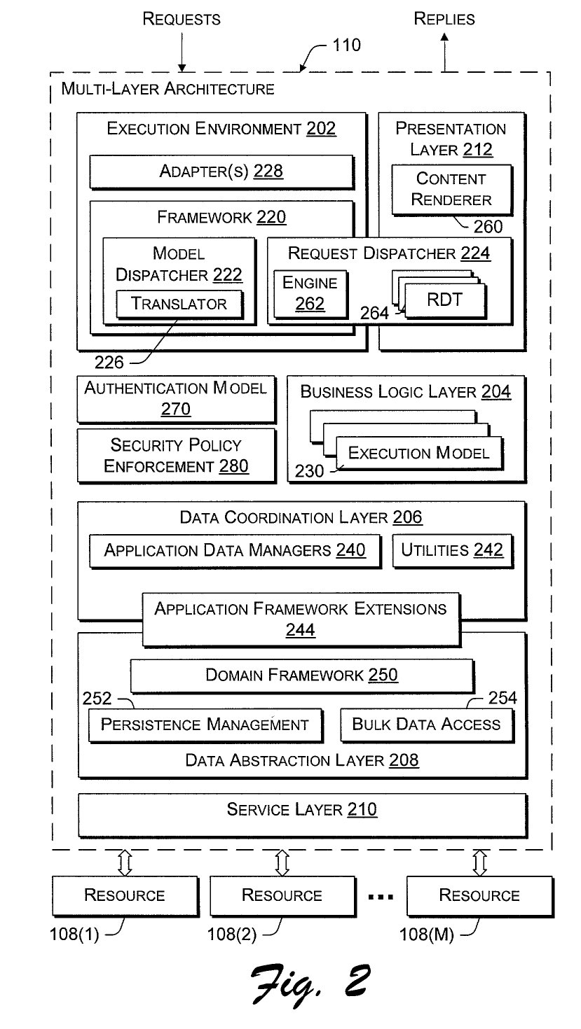

FIG. 2 illustrates one exemplary implementation of the multi-layer architecture 110 that is configured as a server application for a business-oriented domain. The architecture is logically partitioned into multiple layers to promote flexibility in adapting the architecture to different problem domains. Generally, the architecture 110 includes an execution environment layer 202, a business logic layer 204, a data coordination layer 206, a data abstraction layer 208, a service layer 210, and a presentation layer 212. The layers are illustrated vertically to convey an understanding as to how requests are received and handled by the various layers.

Client requests are received at the execution environment 202 and passed to the business logic layer 204 for processing according to the specific business application. As the business logic layer 204 desires information to fulfill the requests, the data coordination layer 206, data abstraction layer 208, and service layer 210 facilitate extraction of the information from the external resources 108. When a reply is completed, it is passed to the execution environment 202 and presentation layer 212 for serving back to the requesting client.

The architecture 110 can be readily modified to (1) implement different applications for different domains by plugging in the appropriate business logic in the business logic layer 204, (2) support different client devices by configuring suitable modules in the execution environment 202 and presentation layer 212, and (3) extract information from diverse resources by inserting the appropriate modules in the data abstraction layer 208 and service layer 210. The partitioned nature of the architecture allows these modifications to be made independently of one another. As a result, the architecture 110 can be adapted to many different domains by interchanging one or more modules in selected layers without having to reconstruct entire application solutions for those different domains.

The execution environment 202 contains an execution infrastructure to handle requests from clients. In one sense, the execution environment acts as a container into which the business logic layer 204 may be inserted. The execution environment 202 provides the interfacing between the client devices and the business logic layer 204 so that the business logic layer 204 need not understand how to communicate directly with the client devices.

The execution environment 202 includes a framework 220 that receives the client requests and routes the requests to the appropriate business logic for processing. After the business logic generates replies, the framework 220 interacts with the presentation layer 212 to prepare the replies for return to the clients in a format and protocol suitable for presentation on the clients.

The framework 220 is composed of a model dispatcher 222 and a request dispatcher 224. The model dispatcher 222 routes client requests to the appropriate business logic in the business logic layer 204. It may include a translator 226 to translate the requests into an appropriate form to be processed by the business logic. For instance, the translator 226 may extract data or other information from the requests and pass in this raw data to the business logic layer 204 for processing. The request dispatcher 224 formulates the replies in a way that can be sent and presented at the client. Notice that the request dispatcher is illustrated as bridging the execution environment 202 and the presentation layer 212 to convey the understanding that, in the described implementation, the execution environment and the presentation layer share in the tasks of structuring replies for return and presentation at the clients.

One or more adapters 228 may be included in the execution environment layer 202 to interface the framework 220 with various client types. As an example, one adapter may be provided to receive requests from a communications device using WAP, while another adapter may be configured to receive requests from a client browser using HTTP, while a third adapter is configured to receive requests from a messaging service using a messaging protocol.

The business logic layer 204 contains the business logic of an application that processes client requests. Generally speaking, the business logic layer contains problem-solving logic that produces solutions for a particular problem domain. In this example, the problem domain is a commerce-oriented problem domain (e.g., asset lending, asset management, insurance, etc.), although the architecture 110 can be implemented in non-business contexts. The logic in the logic layer is therefore application-specific and hence, is written on a per-application basis for a given domain.

In the illustrated implementation, the business logic in the business logic layer 204 is constructed as one or more execution models 230 that define how computer programs process the client requests received by the application. The execution models 230 may be constructed in a variety of ways. One exemplary execution model employs an interaction-based definition in which computer programs are individually defined by a series of one or more interaction definitions based on a request-response model. Each interaction definition includes one or more command definitions and view definitions. A command definition defines a command whose functionality may be represented by an object that has various attributes and that provides the behavior for that command. A view definition defines a view that provides a response to a request.

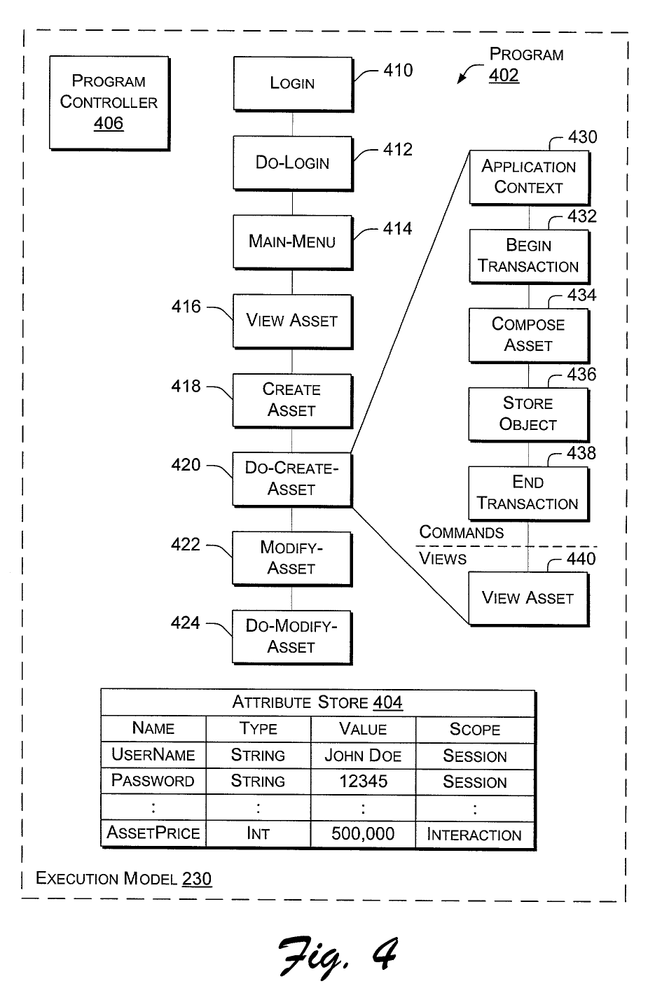

One example of an interaction-based model is a command bean model that employs multiple discrete program modules, called “Command Beans”, that are called for and executed. The command bean model is based on the “Java Bean” from Sun Microsystems, which utilizes discrete Java™ program modules. One particular execution model 230 that implements an exemplary program is described below beneath the heading “Business Logic Layer” with reference to FIGS. 4-6.

Other examples of an execution model include an action-view model and a use case model. The action-view model employs action handlers that execute code and provide a rendering to be served back to the client. The use case model maps requests to predefined UML (Unified Modeling Language) cases for processing.

The data coordination layer 206 provides an interface for the business logic layer 204 to communicate with a specific domain framework 250 implemented in the data abstraction layer 208 for a specific problem domain. In one implementation, the framework 250 utilizes a domain object model to model information flow for the problem domain. The data coordination layer 206 effectively partitions the business logic layer 204 from detailed knowledge of the domain object model as well as any understanding regarding how to obtain data from the external resources.

The data coordination layer 206 includes a set of one or more application data managers 240, utilities 242, and framework extensions 244. The application data managers 240 interface the particular domain object model in the data abstraction layer 208 into a particular application solution space of the business logic layer 204. Due to the partitioning, the execution models 230 in the business logic layer 204 are able to make calls to the application data managers 240 for specific information, without having any knowledge of the underlying domain or resources. The application data managers 240 obtain the information from the data abstraction layer 208 and return it to the execution models 230. The utilities 242 are a group of reusable, generic, and low-level code modules that developers may utilize to implement the interfaces or provide rudimentary tools for the application data managers 240.

The data abstraction layer 208 maps the domain object model to the various external resources 108. The data abstraction layer 208 contains the domain framework 250 for mapping the business logic to a specific problem domain, thereby partitioning the business applications and application managers from the underlying domain. In this manner, the domain framework 250 imposes no application-specific semantics, since it is abstracted from the application model. The domain framework 250 also does not dictate any functionality of services, as it can load any type of functionality (e.g., Java™ classes, databases, etc.) and be used to interface with third-party resources.

Extensions 244 to the domain framework 250 can be constructed to help interface the domain framework 250 to the application data managers 240. The extensions can be standardized for use across multiple different applications, and collected into a library. As such, the extensions may be pluggable and removable as desired. The extensions 244 may reside in either or both the data coordination layer 206 and the data abstraction layer 208, as represented by the block 244 straddling both layers.

The data abstraction layer 208 further includes a persistence management module 252 to manage data persistence in cooperation with the underlying data storage resources, and a bulk data access module 254 to facilitate access to data storage resources. Due to the partitioned nature of the architecture 110, the data abstraction layer 208 isolates the business logic layer 204 and the data coordination layer 206 from the underlying resources 108, allowing such mechanisms from the persistence management module 252 to be plugged into the architecture as desired to support a certain type of resource without alteration to the execution models 230 or application data managers 240.

A service layer 210 interfaces the data abstraction layer 208 and the resources 108. The service layer 210 contains service software modules for facilitating communication with specific underlying resources. Examples of service software modules include a logging service, a configuration service, a serialization service, a database service, and the like.

The presentation layer 212 contains the software elements that package and deliver the replies to the clients. It handles such tasks as choosing the content for a reply, selecting a data format, and determining a communication protocol. The presentation layer 212 also addresses the “look and feel” of the application by tailoring replies according to a brand and user-choice perspective. The presentation layer 212 is partitioned from the business logic layer 204 of the application. By separating presentation aspects from request processing, the architecture 110 enables the application to selectively render output based on the types of receiving devices without having to modify the logic source code at the business logic layer 204 for each new device. This allows a single application to provide output for many different receiving devices (e.g., web browsers, WAP devices, PDAs, etc.) and to adapt quickly to new devices that may be added in the future.

In this implementation, the presentation layer 212 is divided into two tiers: a presentation tier and a content rendering tier. The request dispatcher 224 implements the presentation tier. It selects an appropriate data type, encoding format, and protocol in which to output the content so that it can be carried over a network and rendered on the client. The request dispatcher 224 is composed of an engine 262, which resides at the framework 220 in the illustrated implementation, and multiple request dispatcher types (RDTs) 264 that accommodate many different data types, encoding formats, and protocols of the clients. Based on the client device, the engine 262 makes various decisions relating to presentation of content on the device. For example, the engine might select an appropriate data encoding format (e.g. HTML, XML, EDI, WML, etc.) for a particular client and an appropriate communication protocol (e.g. HTTP, Java™ RMI, CORBA, TCP/IP, etc.) to communicate the response to the client. The engine 262 might further decide how to construct the reply for visual appearance, such as selecting a particular layout, branding, skin, color scheme, or other customization based on the properties of the application or user preference. Based on these decisions, the engine 262 chooses one or more dispatcher types 264 to structure the reply.

A content renderer 260 forms the content rendering tier of the presentation layer 212. The renderer 260 performs any work related to outputting the content to the user. For example, it may construct the output display to accommodate an actual width of the user's display, elect to display text rather than graphics, choose a particular font, adjust the font size, determine whether the content is printable or how it should be printed, elect to present audio content rather than video content, and so on.

With the presentation layer 212 partitioned from the execution environment 202, the architecture 110 supports receiving requests in one format type and returning replies in another format type. For example, a user on a browser-based client (e.g., desktop or laptop computer) may submit a request via HTTP and the reply to that request may be returned to that user's PDA or wireless communications device using WAP. Additionally, by partitioning the presentation layer 212 from the business logic layer 204, the presentation functionality can be modified independently of the business logic to provide new or different ways to serve the content according to user preferences and client device capabilities.

The architecture 110 may include one or more other layers or modules. One example is an authentication model 270 that performs the tasks of authenticating clients and/or users prior to processing any requests. Another example is a security policy enforcement module 280 that supports the security of the application. The security enforcement module 280 can be implemented as one or more independent modules that plug into the application framework to enforce essentially any type of security rules. New application security rules can be implemented by simply plugging in a new system enforcement module 280 without modifying other layers of the architecture 110.

General Operation

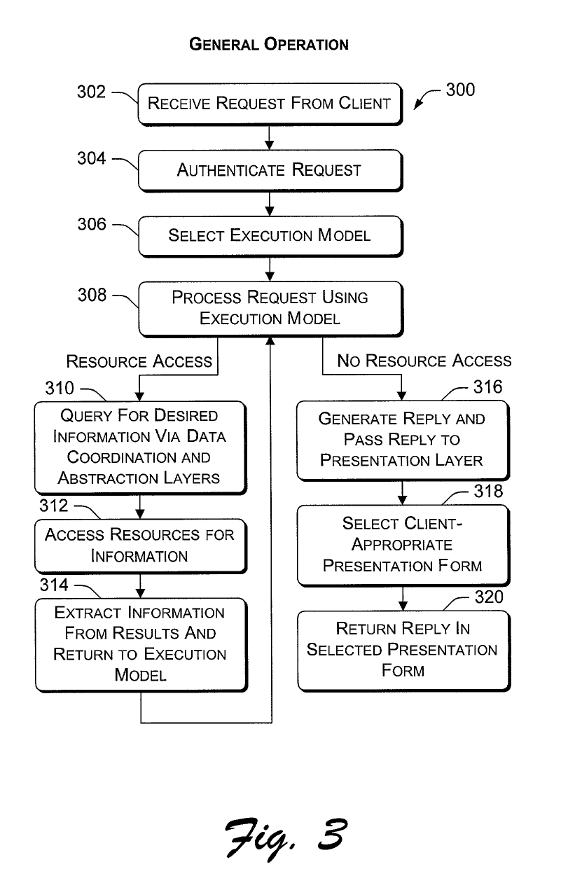

FIG. 3 shows an exemplary operation 300 of a business domain application constructed using the architecture 110 of FIGS. 1 and 2. The operation 300 is implemented as a software process of acts performed by execution of software instructions. Accordingly, the blocks illustrated in FIG. 3 represent computer-readable instructions, that when executed at the server system 106, perform the acts stipulated in the blocks.

To aid the discussion, the operation will be described in the context of asset management, wherein the architecture 110 is configured as a server application executing on the application server system 106 for an asset management domain. Additionally, for discussion purposes, suppose a user is equipped with a portable wireless communications device (e.g., a cellular phone) having a small screen with limited display capabilities and utilizing WAP to send/receive messages over a wireless cellular network. The user submits a request for information on a particular asset, such as the specification of a turbine engine or the availability of an electric pump, from the wireless communications device.

At block 302, requests from various clients are received at the execution environment layer 202. Depending on the client type, one or more adapters 228 may be involved to receive the requests and convert them to a form used internally by the application 110. In our example, the execution environment layer 202 receives the request from the wireless cellular network. An adapter 228 may be utilized to unwrap the request from its WAP-based packet for internal processing.

At block 304, the execution framework 202 may pass the request, or data extracted from the request, to the authentication model 270 for authentication of the client and/or user. If the requestor is not valid, the request is denied and a service denied message (or other type of message) is returned to the client. Assuming the request is valid, the authentication model 270 returns its approval.

At block 306, the model dispatcher 222 routes the request to one or more execution models 230 in the business logic layer 204 to process the client request. In our example, the model dispatcher 222 might select selects an execution model 230 to retrieve information on the particular asset. A translator 226 may be invoked to assist in conforming the request to a form that is acceptable to the selected execution model.

At block 308, the execution model 230 begins processing the request. Suppose, for example, that the selected execution model is implemented as a command bean model in which individual code sequences, or “command beans”, perform discrete tasks. One discrete task might be to initiate a database transaction, while another discrete task might be to load information pertaining to an item in the database, and a third discrete task might be to end the transaction and return the results.

The execution model 230 may or may not need to access information maintained at an external resource. For simple requests, such as an initial logon page, the execution model 230 can prepare a reply without querying the resources 108. This is represented by the “No Resource Access” branch in FIG. 3. For other requests, such as the example request for data on a particular asset, the execution model may utilize information stored at an external resource in its preparation of a reply. This is illustrated by the “Resource Access” branch.

When the execution model 230 reaches a point where it wishes to obtain information from an external resource (e.g., getting asset specific information from a database), the execution model calls an application data manager 240 in the data coordination layer 206 to query the desired information (i.e., block 310). The application data manager 240 communicates with the domain framework 250 in the data abstraction layer 208, which in turn maps the query to the appropriate resource and facilitates access to that resource via the service layer 210 (i.e., block 312). In our example, the domain framework is configured with an asset management domain object model that controls information flow to external resources—storage systems, inventory systems, etc.—that maintain asset information.

At block 314, results are returned from the resource and translated at the domain framework 250 back into a raw form that can be processed by the execution model 230. Continuing the asset management example, a database resource may return specification or availability data pertaining to the particular asset. This data may initially be in a format used by the database resource. The domain framework 250 extracts the raw data from the database-formatted results and passes that data back through the application data managers 240 to the execution model 230. In this manner, the execution model 230 need not understand how to communicate with the various types of resources directly, nor understand the formats employed by various resources.

At block 316, the execution model completes execution using the returned data to produce a reply to the client request. In our example, the command bean model generates a reply containing the specification or availability details pertaining to the requested asset. The execution model 230 passes the reply to the presentation layer 212 to be structured in a form that is suitable for the requesting client.

At block 318, the presentation layer 212 selects an appropriate format, data type, protocol, and so forth based on the capabilities of the client device, as well as user preferences. In the asset management example, the client device is a small wireless communication device that accepts WAP-based messages. Accordingly, the presentation layer 212 prepares a text reply that can be conveniently displayed on the small display and packages that reply in a format supported by WAP. At block 320, the presentation layer 212 transmits the reply back to the requesting client using the wireless network.

Business Logic Layer

The business logic layer 204 contains one or more execution models that define how computer programs process client requests received by the application. One exemplary execution model employs an interaction-based definition in which computer programs are individually defined by a series of one or more interaction definitions based on a request-response model. Each interaction definition includes command definitions and view definitions. A command definition defines a command whose functionality may be represented by an object that has various attributes and that provides the behavior for that command. A view definition defines a view that provides a response to a request.

Each interaction of a computer program is associated with a certain type of request. When a request is received from the model dispatcher 222, the associated interaction is identified to perform the behavior of the commands defined by that interaction. The execution model automatically instantiates an object associated with each command defined in a command definition. Prior to performing the behavior of a command, the execution model prepares the instantiated object by identifying one or more input attributes of that object (e.g., by retrieving the class definition of the object) and setting the input attributes (e.g., by invoking set methods) of the object based on the current value of the attributes in an attribute store.

After setting the attribute values, the execution model performs the behavior of the object (e.g., by invoking a perform method of the object). After the behavior is performed, the execution model extracts the output attributes of the object by retrieving the values of the output attributes (e.g., by invoking get methods of the object) and storing those values in the attribute store. Thus, the attribute store stores the output attributes of each object that are then available to set the input attributes of other objects.

The execution model may serially perform the instantiation, preparation, performance, and extraction for each command. Alternatively, the execution of commands can be performed in parallel depending on the data dependencies of the commands. Because the execution model automatically prepares an object based on the current values in the attribute store and extracts attribute values after performing the behavior of the object, a programmer does not need to explicitly specify the invocation of methods of objects (e.g., “object.setAttribute1=15”) when developing a computer program to be executed by the execution model.

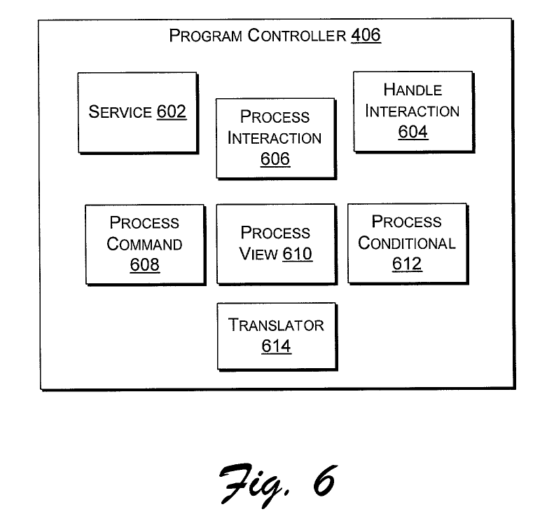

FIG. 4 shows an exemplary execution model 230 configured for an asset catalog application that allows a user to view, create, and modify information relating to assets (e.g., products) stored in an electronic catalog. The model 230 includes an asset catalog program 402, an attribute store 404, and a program controller 406. The asset catalog program 402 includes eight interactions: login 410, do-login 412, main-menu 414, view-asset 416, create-asset 418, do-create-asset 420, modify-asset 422, and do-modify-asset 424. The controller 406 executes the program 402 to perform the various interactions. One exemplary implementation of the controller is described below in more detail with reference to FIG. 6.

Upon receiving a request, the controller 406 invokes the corresponding interaction of the program 402 to perform the behavior and return a view so that subsequent requests of the program can be made. The do-create-asset interaction 420, for example, is invoked after a user specifies the values of the attributes of a new asset to be added to the asset catalog. Each interaction is defined by a series of one or more command definitions and a view definition. Each command definition defines a command (e.g., object class) that provides a certain behavior. For instance, the do-create-asset interaction 420 includes five command definitions—application context 430, begin transaction 432, compose asset 434, store object 436, and end transaction 438—and a view definition named view asset 440.

When the do-create-asset interaction 420 is invoked, the application context command 430 retrieves the current application context of the application. The application context may be used by the interaction to access certain application-wide information. The begin transaction command 432 indicates that a transaction for the asset catalog is beginning. The compose asset command 434 creates an object that identifies the value of the attributes of the asset to be added to the asset catalog. The store object command 436 stores an entry identified by the created object in the asset catalog. The end transaction command 438 indicates that the transaction to the asset catalog has ended. The view asset view 440 prepares a response (e.g., display page) to return to the user.

The attribute store 404 contains an entry for each attribute that has been defined by any interaction of the application that has been invoked. The attribute store identifies a name of the attribute, a type of the attribute, a scope of the attribute, and a current value of the attribute. For example, the last entry in the attribute store 404 has the name of “assetPrice”, with a type of “integer”, a value of “500,000”, and a scope of “interaction”. The scope of an attribute indicates the attribute's life. An attribute with the scope of “interaction” (also known as “request”) has a life only within the interaction in which it is defined. An attribute with the scope of “session” has a life only within the current session (e.g., logon session) of the application. An attribute with the scope of “application” has life throughout the duration of an application.

When the program controller 406 receives a request to create an asset (e.g., a do-create-asset request), the controller invokes the do-create-asset interaction 420. The controller first instantiates an application context object defined in the interaction command 430 and prepares the object by setting its attributes based on the current values of the attribute store 404. The controller then performs the behavior of the object by invoking a perform method of the object and extracts the attribute values of the object by getting the attribute values and storing them in the attribute store 404.

Next, the program controller 406 instantiates a begin transaction object defined by the interaction command 432 and prepares the object by setting its attribute values based on the current values of the attribute store 404. It then performs the behavior of the object by invoking a perform method of the object and extracts the attribute values of the object by getting the attribute values and storing them in the attribute store. The controller 406 repeats this process for a compose-asset object instantiated according to command 434, the store-object object instantiated according to command 436, and the end transaction object instantiated according to command 438. The controller 406 then invokes the view asset 440 to retrieve the values of the attributes of the asset from the attribute store 404 for purposes of presenting those attribute values back to the client.

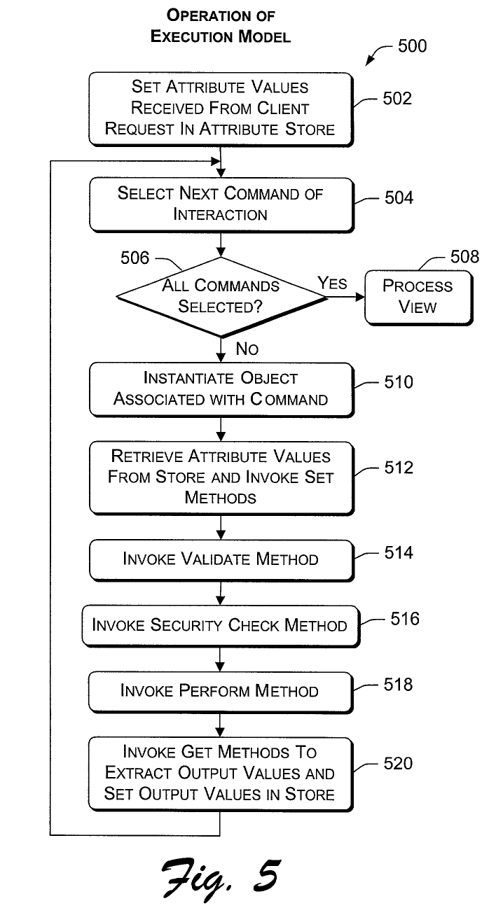

FIG. 5 shows a process 500 implemented by the program controller 406 of the execution model 230 when executing an interaction-based program, such as program 402. The process 500 is implemented in software and hence, the illustrated blocks represent computer-readable instructions, that when executed at the server system 106, perform the stated acts.

At block 502, the controller 406 sets the attribute values from the request in the attribute store 404. For example, a view-asset request may include a value for an “assetID” attribute that uniquely identifies an asset currently stored in the asset catalog. The controller then loops through each command of the interaction associated with the request. At block 504, the controller selects the next command of the interaction associated with the request, starting with the first command. If all commands have already been selected (i.e., the “yes” branch from block 506), the controller 406 processes the view defined in the view definition of the interaction and returns the response to the presentation layer 212 (i.e., block 508).

On the other hand, if not all of the commands have been selected (i.e., the “no” branch from block 506), the controller instantiates an object associated with the selected command (i.e., block 510). The object class associated with the command is specified in the command definition of the interaction. In block 512, the controller 406 prepares the object by retrieving the values of the input attributes of the object from the attribute store 404 and invoking the set methods of the object to set the values of the attributes. At block 514, the controller invokes a validate method of the object to determine whether the current values of the input attributes of the object will allow the behavior of the object to be performed correctly. If the validate method indicates that the behavior cannot be performed, the controller generates an exception and skips further processing of the commands of the interaction.

At block 516, the controller optionally invokes a security check method of the object to determine whether the user that initiated the request is able to perform the action with the object that is indicated by the interaction. The security check method invokes the security policy enforcement 280 of FIG. 2 to perform the security check. The result of the security check is then returned to the security check method of the object, which returns the result to the controller 406.

At block 518, the controller invokes the perform method of the object to perform the behavior of the object. At block 520, the controller extracts the values of the output attribute of the object by invoking the get methods of the object and setting the values of the corresponding attributes in the attribute store 404. The controller then loops to block 504 to select the next command of the interaction.

FIG. 6 shows one exemplary implementation of the controller 406 in more detail. It includes multiple components that are configured according to the request-response model where individual components receive a request and return a response. The controller 406 includes a service component 602 that is invoked to service a request message. The service component 602 stores the value of any attributes specified in the request in the attribute store 404. For example, the component may set the current value of a URL attribute as indicated by the request. Once the attribute values are stored, the service component 602 invokes a handle interaction component 604 and passes on the request. It is noted that the service component will eventually receive a response in return from the handle interaction component 604, which will then be passed back to the presentation layer 212 for construction of a reply to be returned to the client.

The handle interaction component 604 retrieves, from the program database, the interaction definition for the interaction specified in the request. The handle interaction component 604 then invokes a process interaction component 606 and passes the request, response, and the interaction definition.

The process interaction component 606 processes each command and view of the interaction and returns a response. For a given descriptor (i.e., command, view, or conditional) specified in the interaction, the process interaction component identifies the descriptor and invokes an appropriate component for processing. If the descriptor is a command, the process interaction component 606 invokes a process command component 608 to process the command of interaction. If the descriptor is a view, the process interaction component 606 invokes a process view component 610 to process the view of the interaction. If the descriptor is a conditional, the process interaction component 606 invokes a process conditional component 612 to process the conditional of the interaction.

When processing a command, the process command component 608 instantiates the object (e.g., as a “Java bean” in the Java™ environment) for the command and initializes the instantiated object by invoking an initialization method of the object. The process command component invokes a translator component 614 and passes the instantiated object to prepare the object for performing its behavior. A translator component is an object that provides a prepare method and an extract method for processing an object instantiated by the process command component to perform the command. Each command may specify the translator that is to be used for that command. If the command does not specify a translator, a default translator is used.

The translator component 614 sets the attribute values of the passed object based on the current attribute values in the attribute store 404. The translator component 614 identifies any set methods of the object based on a class definition of the object. The class definition may be retrieved from a class database or using a method provided by the object itself. When a set method is identified, the translator component identifies a value of the attribute associated with a set method of the object. The attribute store is checked to determine whether a current value for the attribute of the set method is defined. If the current value of the attribute is defined in the attribute store, the attribute value is retrieved from the attribute store, giving priority to the command definition and then to increasing scope (i.e., interaction, session, and then application). The component performs any necessary translation of the attribute value, such as converting an integer representation of the number to a string representation, and passes back the translated value. When all methods have been examined, the translator component 614 returns control to the process command component 608.

The process command component 608 may also validate the object. If valid, the component performs the behavior of the object by invoking the perform method of the object. The component once again invokes the translator and passes the object to extract the attribute values of the object and store the current attribute values in the attribute store 404.

When processing a view, the process view component 610 either invokes a target (e.g., JSP, ASP, etc.) or invokes the behavior of an object that it instantiates. If a class name is not specified in the definition of the view, the process view component 610 retrieves a target specified in the view definition and dispatches a view request to the retrieved target. Otherwise, if a class name is specified, the process view component 610 performs the behavior of an object that it instantiates. The process view component 610 retrieves a translator for the view and instantiates an object of the type specified in the view definition. The process view component 610 initializes the object and invokes the translator to prepare the object by setting the values of the attributes of the object based on the attribute store. The process view component 610 validates the object and performs the behavior of the object. The process view component 610 then returns.

When processing a conditional, the process conditional component 612 interprets a condition to identify the descriptors that should be processed. The component may interpret the condition based on the current values of the attributes in the attribute store. Then, the process conditional component 612 recursively invokes the process interaction component 606 to process the descriptors (command, view, or conditional) associated with the condition. The process conditional component 612 then returns.

One exemplary form of a program implemented as a document type definition (DTD) is illustrated in Table 1. The interactions defining the program are specified in an XML (“extensible Markup Language”) file.

TABLE 1

| 1. | <!ELEMENT program (translator*,command*,view*,interaction*)> | |
|---|---|---|
| 2. | <!ATTLIST program | |
| 3. | name | ID #REQUIRED |
| 4. | > | |
| 5. | | |
| 6. | <!ELEMENT translator EMPTY> | |
| 7. | <!ATTLIST translator | |
| 8. | name | ID #REQUIRED |
| 9. | class | CDATA #REQUIRED |
| 10. | default | (true\|false) “false” |
| 11. | > | |
| 12. | | |
| 13. | <!ELEMENT translator-ref EMPTY> | |
| 14. | <!ATTLIST translator-ref | |
| 15. | name | IDREF #REQUIRED |
| 16. | > | |
| 17. | | |
| 18. | <!ELEMENT command (translator-ref*, attribute*)> | |
| 19. | <!ATTLIST command | |
| 20. | name | ID #REQUIRED |
| 21. | class | CDATA #REQUIRED |
| 22. | > | |
| 23. | | |
| 24. | <!ELEMENT command-ref (attribute*)> | |
| 25. | <!ATTLIST command-ref | |
| 26. | name | IDREF #REQUIRED |
| 27. | type | (default\|finally) “default” |
| 28. | > | |
| 29. | | |
| 30. | <!ELEMENT attribute EMPTY> | |
| 31. | <!ATTLIST attribute | |
| 32. | name | ID #REQUIRED |
| 33. | value | CDATA #IMPLIED |
| 34. | get-name | CDATA #IMPLIED |
| 35. | set-name | CDATA #IMPLIED |
| 36. | scope | (application\|request\|session) “request” |
| 37. | > | |
| 38. | | |
| 39. | <!ELEMENT view> | |
| 40. | <!ATTLIST view | |
| 41. | name | ID #REQUIRED |
| 42. | target | CDATA #REQUIRED |
| 43. | type | (default\|error) “default” |
| 44. | default | (true\|false) “false” |
| 45. | > | |
| 46. | | |
| 47. | <!ELEMENT view-ref> | |
| 48. | <!ATTLIST view-ref | |
| 49. | name | IDREF #REQUIRED |
| 50. | > | |
| 51. | | |
| 52. | <!ELEMENT if (#PCDATA)> | |
| 53. | <!ELEMENT elsif (#PCDATA)> | |
| 54. | <!ELEMENT else EMPTY> | |
| 55. | <!ELEMENT conditional (if?, elsif*, else*, command-ref*, view-ref*, conditional*)> | |
| 56. | | |
| 57. | !ELEMENT interaction (command-ref*,view-ref*,conditional*)> | |
| 58. | <!ATTLIST interaction | |
| 59. | name | ID #REQUIRED |

| | |
|---|---|
| 60. | > |

Lines 1-4 define an program tag, which is the root tag of the XML file. The program tag can include translator, command, view, and interaction tags. The program tag includes a name attribute that specifies the name of the program. Lines 6-11 define a translator tag of the translator, such as translator 614. The name attribute of the translator tag is a logical name used by a command tag to specify the translator for that command. The class attribute of the translator tag identifies the class for the translator object. The default attribute of the translator tag indicates whether this translator is the default 110 translator that is used when a command does not specify a translator.

Lines 13-16 define a translator-ref tag that is used in a command tag to refer back to the translator to be used with the command. The name attribute of the translator-ref tag identifies the name of the translator to be used by the command. Lines 18-22 define a command tag, which may include translator-ref tags and attribute tags. The translator-ref tags specify names of the translators to be used by this command and the attribute tags specify information relating to attributes of the command. The name attribute of the command tag provides the name of the command. The class attribute of the command tag provides the name of the object class that provides the behavior of the command.

Lines 24-28 define a command-ref tag that is used by an interaction tag (defined below) to specify the commands within the interaction. The command reference tag may include attribute tags. The name attribute of the command-ref tag specifies the logical name of the command as specified in a command tag. The type attribute of the command-ref tag specifies whether the command should be performed even if an exception occurs earlier in the interaction. The value of “finally.” means that the command should be performed.

Lines 30-37 define an attribute tag, which stipulates how attributes of the command are processed. The name attribute of the attribute tag specifies the name of an attribute. The value attribute of the attribute tag specifies a value for the attribute. That value is to be used when the command is invoked to override the current value for that attribute in the attribute store. The get-name attribute of the attribute tag specifies an alternate name for the attribute when getting an attribute value. The set-name attribute of the attribute tag specifies an alternate name for the attribute when setting an attribute value. The scope attribute of the attribute tag specifies whether the scope of the attribute is application, request (or interaction), or session.

Lines 39-45 define a view tag that stipulates a view. The name attribute of the view tag specifies the name of the view. The target attribute of a view tag specifies the JSP target of a view. The type attribute of the view tag specifies whether the view should be invoked when there is an error. The default attribute of the view tag specifies whether this view is the default view that is used when an interaction does not explicitly specify a view.

Lines 47-50 define a view-ref tag, which is included in interaction tags to specify that the associated view is to be included in the interaction. The name attribute of the view-ref tag specifies the name of the referenced view as indicated in a view tag. Lines 52-55 define tags used for conditional analysis of commands or views. A conditional tag may include an “if” tag, an “else if” tag, an “else” tag, a command-ref tag, a view-ref tag, and a conditional tag. The data of the “if” tag and the “else if” tag specify a condition (e.g., based on attribute values in the attribute store) that defines the commands or view that are to be conditionally performed when executing interaction.

Lines 57-60 define an interaction tag, which defines a sequence of command, view, or conditional tags of an interaction. The interaction tag may include command-ref, view-ref and conditional tags. The name attribute of the interaction tag identifies the name of the interaction. The requests passed into the execution model specify the name of the interaction to execute.

Table 2 provides an example XML file for the asset catalog program 402 illustrated in FIG. 4 and described above. Line 1 includes a program tag with the name of the program “asset catalog”. Lines 2-3 specify the default translator for the program. Lines 5-11 define the various commands associated with the program. For example, as indicated by line 7, the command named “login” is associated with the class “demo.cb.Login.” Whenever a login command is performed, an object of class “demo.cb.Login” is used to provide the behavior.

Lines 13-20 define the views of the program. For example, line 14 illustrates that the view named “view-asset” (i.e., view 440 in FIG. 4) is invoked by invoking the target named “htmj/view-assetjsp.” Lines 23-119 define the various interactions that compose the program. For example, lines 42-53 define the view-asset interaction 416 as including command-ref tags for each command defined in the interaction. The conditional tag at lines 47-52 defines a conditional view such that if a login user has administrator permission, the “view-asset-admin” view is invoked; otherwise, the “view-asset” view is invoked. Lines 88-90 illustrate the use of an attribute tag used within a command tag. The attribute tag indicates that the attribute named “object” is an input attribute of the command that corresponds to the attribute named “asset” in the attribute store 404.

TABLE 2

| | |
|---|---|
| 1. | <program name=“asset catalog”> |
| 2. | <translator name=“default-trans” class=“com.ge.dialect.cb.DefaultTranslator” |
| 3. | default=“true”/> |
| 4. | |
| 5. | <command name=“app-ctx” class=“demo.cb.AppCtx”/> |
| 6. | <command name=“begin-tx” class=“demo.cb.BeginTx”/> |
| 7. | <command name=“login” class=“demo.cb.Login”/> |
| 8. | <command name=“load-asset” class=“demo.cb.LoadAsset”/> |
| 9. | <command name=“compose-asset” class=“demo.cb.ComposeAsset”/> |
| 10. | <command name=“store-object” class=“demo.cb.StoreObject”/> |
| 11. | <command name=“end-tx” class=“demo.cb.EndTx”/> |
| 12. | |
| 13. | <view name=“error-view” target=“html/error.jsp” type=“error” default=“true”/> |
| 14. | <view name=“view-asset” target=“html/view-asset.jsp”/> |
| 15. | <view name=“view-asset-admin” target=“html/view-asset-admin.jsp”/> |
| 16. | <view name=“create-asset” target=“html/create-asset.jsp”/> |
| 17. | <view name=“modify-asset” target=“html/modify-asset.jsp”/> |
| 18. | <view name=“login” target=“html/login.jsp”/> |
| 19. | <view name=“login-error” target=“html/login.jsp” type=“error”/> |
| 20. | <view name=“main-menu” target=“html/main-menu.jsp”/> |
| 21. | |
| 22. | |
| 23. | <interaction name=“login”> |
| 24. | <view-ref name=“login”/> |
| 25. | </interaction> |
| 26. | |
| 27. | <interaction name=“do-login”> |
| 28. | <command-ref name=“app-ctx”/> |
| 29. | <command-ref name=“begin-tx”/> |
| 30. | <command-ref name=“login”> |
| 31. | <attribute name=“loginUser” scope=“session”/> |
| 32. | </command-ref> |
| 33. | <command-ref name=“end-tx” type=“finally”/> |
| 34. | <view-ref name=“main-menu”/> |
| 35. | <view-ref name=“login-error”/> |
| 36. | </interaction> |
| 37. | |
| 38. | <interaction name=“main-menu”> |
| 39. | <view-ref name=“main-menu”/> |
| 40. | </interaction> |
| 41. | |
| 42. | <interaction name=“view-asset”> |
| 43. | <command-refname=“app-ctx”/> |
| 44. | <command-ref name=“begin-tx”/> |
| 45. | <command-ref name=“load-asset”/> |
| 46. | <command-ref name=“end-tx” type=“finally”/> |
| 47. | <conditional> |
| 48. | <if>(loginUser != void) &amp;&amp; loginUser.hasPermission(“admin”)</if> |
| 49. | <view-ref name=“view-asset-admin”/> |
| 50. | <else/> |
| 51. | <view-ref name=“view-asset”/> |
| 52. | </conditional> |
| 53. | </interaction> |
| 54. | |
| 55. | <interaction name=“create-asset”> |
| 56. | <view-ref name=“create-asset”/> |
| 57. | </interaction> |
| 58. | |
| 59. | <interaction name=“do-create-asset”> |
| 60. | <command-ref name=“app-ctx”/> |
| 61. | <command-ref name=“begin-tx”/> |
| 62. | <command-ref name=“compose-asset”/> |
| 63. | <command-ref name=“store-object”> |
| 64. | <attribute name=“object” get-name=“asset”/> |
| 65. | </command-ref> |
| 66. | <command-ref name=“end-tx” type=“finally”/> |
| 67. | <conditional> |
| 68. | <if>(loginUser != void) &amp;&amp; loginUser.hasPermission(“admin”)</if> |
| 69. | <view-ref name=“view-asset-admin”/> |
| 70. | <else/> |
| 71. | <view-ref name=“view-asset”/> |
| 72. | </conditional> |
| 73. | </interaction> |
| 74. | |
| 75. | <interaction name=“modify-asset”> |
| 76. | <command-ref name=“app-ctx”/> |
| 77. | <command-ref name=“begin-tx”/> |
| 78. | <command-ref name=“load-asset”/> |
| 79. | <command-ref name=“end-tx” type=“finally”/> |
| 80. | <view-ref name=“modify-asset”/> |
| 81. | </interaction> |
| 82. | |
| 83. | <interaction name=“do-modify-asset”> |
| 84. | <command-ref name=“app-ctx”/> |
| 85. | <command-ref name=“begin-tx”/> |
| 86. | <command-ref name=“load-asset”/> |
| 87. | <command-ref name=“compose-asset”/> |
| 88. | <command-ref name=“store-object”> |
| 89. | <attribute name=“object” get-name=“asset”/> |
| 90. | </command-ref> |
| 91. | <command-ref name=“end-tx” type=“finally”/> |
| 92. | <conditional> |
| 93. | <if>(loginUser != void) &amp;&amp; loginUser.hasPermission(“admin”)</if> |
| 94. | <view-ref name=“view-asset-admin”/> |
| 95. | <else/> |
| 96. | <view-ref name=“view-asset”/> |
| 97. | </conditional> |
| 98. | </interaction> |
| 99. | |
| 100. | |
| 101. | <interaction name=“view-error2”> |
| 102. | <conditional> |
| 103. | <if>“A”.equals(“B”)</if> |
| 104. | <command-ref name=“begin-tx”/> |
| 105. | <command-ref name=“load-asset”/> |
| 106. | <command-ref name=“end-tx” type=“finally”/> |
| 107. | <elsif>“NEVER”.equals(“EQUAL”)</elsif> |
| 108. | <command-ref name=“load-asset”/> |
| 109. | <command-ref name=“end-tx” type=“finally”/> |
| 110. | </conditional> |
| 111. | <view-ref name=“view-asset”/> |
| 112. | </interaction> |
| 113. | |
| 114. | |
| 115. | <interaction name=“view-error”> |
| 116. | <command-ref name=“load-asset”/> |
| 117. | <command-ref name=“end-tx” type=“finally”/> |
| 118. | <view-ref name=“view-asset”/> |
| 119. | </interaction> |
| 120. | |
| 121. | </program> |

Security Enforcement Model

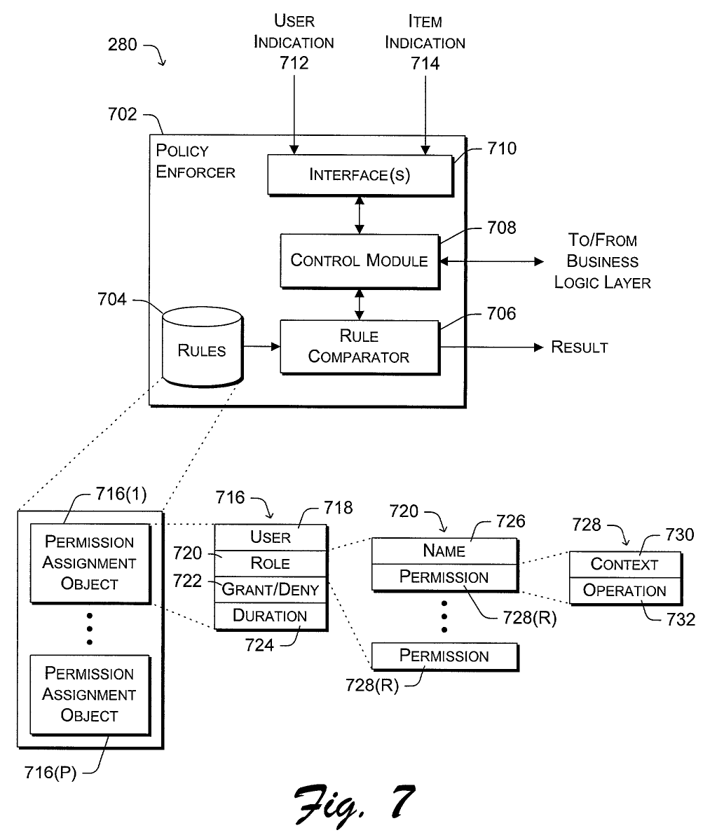

FIG. 7 illustrates one exemplary implementation of the security policy enforcement 280 of FIG. 2. The security policy enforcement 280 includes a policy enforcer 702 having a set of one or more rules 704, a rule comparator 706, a control module 708, and one or more interfaces 710. The policy enforcer 702 can be implemented in a variety of different manners, such as an object, a set of remotely callable functions or procedures, and so forth.

Generally, the policy enforcer 702 receives a user indication 712 and an item indication 714 via the interface 710, along with an indication of the type of security operation/check requested by the calling component (e.g., business logic layer 204). The user indication 712 identifies the user that is making the request that resulted in the security operation (e.g., the user currently logged into the application as identified by a user ID in the attribute store 404 of FIG. 4). The item indication 714 identifies the item that the identified user is trying to access that resulted in the security operation. The items that a user may attempt to access can vary by application (e.g., an asset in a database, a customer's loan information, another user's logon id or password, etc.).

Depending on the nature of the user indication, the control module 708 may access the business logic layer 204 of FIG. 2 for additional information regarding the requested security operation. The rule comparator 706 compares the received user and item indications 712 and 714 to the rules 704 to determine whether a rule indicates the requested security operation should pass or fail. Any additional information received by the control module 708 from the business logic layer 204 may also be compared to the rules 704, or the additional information may identify other checks to be performed. The comparator 706 then returns a result of the security operation (e.g., a pass or fail indication) to the component that requested the security operation (e.g., the business logic layer 204). The results of a failed or passed security operation are then dependent on the calling component.

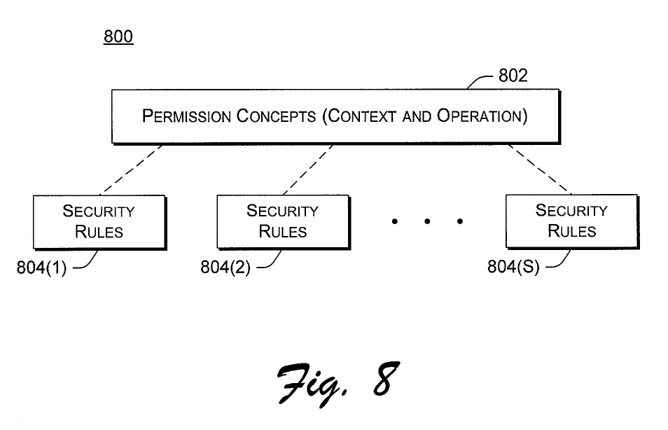

FIG. 8 illustrates an exemplary method 800 of expressing security rules. Initially, a set of high-level permission concepts 802 are defined. In the discussions herein, the high-level permission concepts 802 are referred to as the “context” and the “operation”. The operation identifies a particular operation or action that may be defined (e.g., creation, deletion, modification, etc.) and the context identifies what a corresponding operation may be performed on (e.g., a user object, an asset object, etc.). Based on these high-level permission concepts 802, multiple security rules 804(1), 804(2), . . . , 804(S) can be defined that are specific to a particular application domain or business logic. These defined rules 804 are then used as the rules 704 of FIG. 7.

Returning to FIG. 7, the policy enforcer 702 can be invoked to perform a security operation by a variety of different components. In one implementation, the program controller 406 of FIG. 4 invokes a security check method of an instantiated object and identifies the user object to the security check method. The invoked security check method then invokes the policy enforcer 702, passing the user object (as indication 712) as well as an indication of the object that the requested operation affects (as indication 714), such as an asset in a database to the policy enforcer 702.

Alternatively, the policy enforcer 702 may be invoked in other manners, such as by another component interacting with or managing objects (e.g., the program controller 406 of FIG. 4). In some situations the indication of the object is inherent in the invocation of the policy enforcer 702 and only the user indication 712 need be explicitly passed to the policy enforcer 702. For example, an object may invoke the policy enforcer 702 for a security operation to determine whether a particular user (represented by a user object) is able to access the object invoking the policy enforcer. In this example, the item indication is implicitly passed to the policy enforcer 702 by nature of its being invoked by another object.

The interface 710 provides multiple different interfaces or methods that can be used to invoke one of multiple different security operations of the policy enforcer 702. Each interface receives an indication of the user and the item corresponding to the requested security operation. In one implementation, multiple sets of interfaces are provided by the interface 710: one set that is invoked by a component where the item indication is implicit, and another set that is invoked by a component where the item indication is explicitly identified. An exemplary interface 710 provides the following five different interfaces or methods: canBeApprovedBy, canBeCreatedBy, canBeDeletedBy, canBeModifiedBy, and canBeViewedBy.

The canBeApprovedBy method tests whether the identified item can be approved by the specified user. For example, approval typically happens for entities such as quotes or orders where a supervisor approves or rejects an action taken by other personnel or through automated processes. The rules which determine whether an item can be approved by a particular user can be arbitrary and partially based on other information available in the business logic other than the item and the user. The canBeApprovedBy method returns true (pass) if the user can approve or reject an action taken on the object or false (fail) if the user cannot perform those actions.

The canBeCreatedBy method tests whether the identified item of the specified type (e.g., class) can be created by the specified user. This method is used when testing whether or not a user can create a certain type of persistent item (e.g., a persistent object). Persistent items are those that are stored into a database or other type of long-term storage for future retrieval. The business rules which determine whether an item can be created by a particular user can be arbitrary and partially based on other information available in the business logic other than the item and the user. The canBeCreatedBy method returns true (pass) if the user can create the item in question, false (fail) otherwise.

The canBeDeletedBy method tests whether the identified item can be deleted (destroyed) by the specified user. This method is used when testing whether or not a user can delete an individual persistent item. The business rules which determine whether an item can be deleted by a particular user can be arbitrary and partially based on other information available in the business logic other than the object and the user. The canBeDeletedBy method returns true (pass) if the user can delete the item in question, false (fail) otherwise.

The canBeModifiedBy method tests whether the identified item can be modified (changed) by the specified user. This method is used when testing whether or not a user can modify an individual persistent item. The business rules which determine whether an item can be modified by a particular user can be arbitrary and partially based on other information available in the business logic other than the item and the user. The canBeModifiedBy method returns true (pass) if the user can modify the item in question, false (fail) otherwise.

The canBeViewedBy method tests whether a user can examine the details of a particular item. The business rules which determine that a given item may be examined by the specific user can be arbitrary and partially based on other information available in the business logic other than the item and the user. The canBeViewedBy method returns true (pass) if the user can view the contents of the item in question, false (fail) otherwise.

When a security operation is requested, the policy enforcer 702 uses one or more of the rules 704 to determine whether to respond to the request with a pass or fail result. Each of the rules 704 is referred to as a permission assignment object 716, serving to assign one or more particular permissions to a particular user or group of users. Multiple such permission assignment objects 716(1), . . . , 716(P) can be included in the rules 704.

Each permission assignment object 716 includes a user field 718, a role field 720, a permission (grant/deny) field 722, and a duration field 724. The user field 718 identifies a particular user or group of users for which the permission assignment object 716 identifies permissions. The role field 720 identifies a set of one or more permissions, allowing multiple permissions to be grouped together under a single identifier. The role field 720 includes two or more additional fields: a name field 726 and a set of one or more permission fields 728(1), . . . , 728(R). The name field 726 is an identifier of the associated set of permissions 728. Each permission field 728 includes two additional fields to define a particular permission: a context field 730 and an operation field 732. The operation field 732 identifies a particular operation (e.g., creation, deletion, modification, etc.) and the context field 730 identifies what that particular operation is performed on (e.g., a user object, an asset object, etc.). Alternatively, the role field 720 may contain an individual permission (just a field 728) rather than a role (a name field 726 and permission field(s) 728).

The grant/deny field 722 of the permission assignment object 716 identifies whether the permission(s) identified in the role field 720 are granted or denied to the user identified in the user field 718. The duration field 724 identifies a time or duration associated with the permission(s) granted or denied by the permission assignment object 716. The time or duration may be specified in a variety of manners (e.g., a start time/date and a number of hours/days/months/etc. from the start time/date that the permission(s) are to last, an ending time/date past which the permission(s) are no longer to be applied, an indication that there is no time at which the permission(s) expire, and so forth).

The particular rules 704 that are included in the policy enforcer 702 vary by business logic. Thus, if a designer wishes to apply different rules because of a change in the business logic, the policy enforcer 702 can simply be swapped out with the new policy enforcer 702 including the new desired rules. The manner in which the policy enforcer 702 is invoked does not change, nor does the permission concept of defining permissions as contexts and operations. The underlying data in those specific permissions changes, but not the permission concepts.

The fields 716-732 may include the actual data for the information they represent or alternatively a pointer to the data. Using a pointer allows, for example, the same permission 728 to be identified multiple different permission assignment objects 716 and/or multiple different roles 720 without duplicating storage of the data of the permission 728 for each object and/or role.

An example set of permissions and associated roles can be seen in Tables 3 and 4 below. These can be used to assign permissions to particular users and/or groups of users by the system designer as he or she chooses. Table 3 describes the various defined permissions, while Table 4 identifies which role(s) the permissions are associated with (an “x” in a cell of Table 4 indicates that the identified permission is associated with the identified role). These permissions and roles are an example set that can be used in an asset sales domain, allowing clients to purchase and sell assets. A permission name is included for identification purposes, though it need not be stored in the rules 704 (and is not stored in the rules 704 in the illustrated example of FIG. 7).

TABLE 3

| Permission | | | |
|---|---|---|---|
| Name | Context | Operation | Description |
| External | Asset | External | Search publicly available assets |
| Search | | Search | |
| Asset | | | |
| Internal | Asset | Internal | Search private assets owned by requestor's |
| Search Own | | Search | organization. Additional requirement: The |
| Asset | | Own | object was created by the requestor |
| | | | (Object.getCreatedBy( ) == User.getID( )). |
| Internal | Asset | Internal | Search all private assets |
| Search All | | Search All | |
| Asset | | | |
| Create | Asset | Create | Create assets |
| Asset | | | |
| Externalize | Asset | Externalize | Make an asset publicly available |
| Asset | | | |
| Modify | Asset | Modify | Modify any asset |
| Asset | | | |
| | Asset | | |
| View Asset | Asset | View | View any asset |
| Delete Asset | Asset | Delete | Delete assets |
| View My | Quote | View Own | Quotes requested by me, created by me or |
| Quote | | | created for me. Additional requirements: |
| | | | the object was created by me |
| | | | (Object.getCreatedBy( ) == User.getID( )), |
| | | | and created for me (Object.getCreatedFor( ) == |
| | | | User.getID( )). |
| View All | Quote | View All | View all quotes |
| Quote | | | |
| Respond | Quote | Respond | Respond to a quote |
| Quote | | | |
| Search For | Quote | Search | Search for quotes requested by me, created |
| My Quote | | Own | by me or created for me |
| Search For | Quote | Search | Search for all quotes |
| All Quote | | All | |
| Delete | Quote | Delete | Delete any quote |
| Quote | | | |
| See Quote | Quote | See | See all quote reports |
| Reports | | Reports | |
| Request | Quote | Request | Create a request for quote |
| For | | For | |
| Quote | | | |
| Create | Quote | Create | Create quote |
| Quote | | | |
| Modify | Quote | Modify | Modify any quote |
| Quote | | | |
| Create | User | Create | Create user |
| User | | | |
| Modify | User | Modify | Modify any user. May not alter any user |
| User | | | that has System Administration permission. |
| Disable | User | Disable | Disable user |
| User | | | |
| Delete | User | Delete | Delete user. May not alter any user that has |
| User | | | System Administration permission. May |
| | | | only delete users if and only if User ID not a |
| | | | foreign key reference in Assets and Quotes. |
| Modify | User | Modify | Modify own User information (except |
| My Info | | Own | permission levels and organization affinity) |
| Create ADP | ADP | Create | Create ADP customer |
| Customer | Customer | | |
| Search | ADP | Search | Search for ADP customers |
| ADP | Customer | | |
| Customer | | | |
| Modify | ADP | Modify | Modify an ADP customer |
| ADP | Customer | | |
| Customer | | | |
| Delete | ADP | Delete | Delete ADP customer |
| ADP | Customer | | |
| Customer | | | |
| System | * | * | System administration privileges. System |
| Admin | | | administrators can perform all other |
| | | | operations. |

TABLE 4

| | | | Sales | | |
|---|---|---|---|---|---|
| | Admin | Internal | Force | ADP | User |
| Permission Name | Role? | Role? | Role? | Role? | Role? |
| External Search Asset | X | X | X | X | X |
| Internal Search Own Asset | X | | | X | |
| Internal Search All Asset | X | X | X | | |
| Create Asset | X | X | | | |
| Externalize Asset | X | X | | | |
| Modify Asset | X | X | | | |
| View Asset | X | X | X | X | X |
| Delete Asset | X | | | | |
| View My Quote | X | X | X | X | X |
| View All Quote | X | X | X | | |
| Respond Quote | X | X | X | | |
| Search For My Quote | X | X | X | X | X |
| Search For All Quote | X | X | X | | |
| Delete Quote | X | X | | | |
| See Quote Reports | X | | | | |
| Request For Quote | X | X | X | X | X |
| Create Quote | X | X | | | |
| Modify Quote | X | X | | | |
| Create User | X | | | | |
| Modify User | X | | | | |
| Disable User | X | | | | |
| Delete User | X | | | | |
| Modify My Info | X | X | X | X | X |
| Create ADP Customer | X | | | | |
| Search ADP Customer | X | | | | |
| Modify ADP Customer | X | | | | |
| Delete ADP Customer | X | | | | |
| System Administration | | | | | |

The rule comparator 706 uses the rules 704 to determine what result to return in response to a requested security operation. The rules 704 can be interpreted as permissive (the default is that the security operation fails unless a rule indicates that it should succeed/pass), or alternatively as impermissive (the default is that the security operation succeeds/passes unless a rule indicates that it should fail). For example, assume that a user having an identifier of “Joe” desires to modify an asset. The policy enforcer 702 receives a security operation request to return a result indicating whether user Joe is able to modify the asset. The rule comparator 706 checks the rules 704 to determine whether there is any rule that grants user Joe permission to modify the asset. Referring to Tables 3 and 4, if a rule has been created that user Joe is granted permission to modify any asset (“Modify Asset” in Tables 3 and 4), such as assigning user Joe to the “Admin” or “Internal” roles, then the requested security operation succeeds/passes (otherwise, it fails).

Additionally, situations can arise where additional information is used by the policy enforcer to determine the result for a security operation. In these situations, the control module 708 communicates with the business logic layer 204 to determine what additional tests or comparisons need to be performed in order to obtain the result of the security operation. These may be additional comparisons required by the rule comparator 706, or alternatively additional instructions executed by the control module 708. For example, the Internal Search Own Asset permission in Tables 3 and 4 indicate that in order for the security operation to succeed the user ID (e.g., “Joe”) indicated in the security operation request must be the same as the user ID of the user that created the item. This additional check can be performed by the control module 708, such as querying the item via a “getCreatedBy” interface on the item that causes the item to return the user ID of its creator. This additional check may also involve additional communication with the business logic layer 204. For example, the business logic layer 204 may include objects or other modules to return the creator of the item. By way of another example, the Modify User permission in Tables 3 and 4 indicate that in order for the security operation to succeed, the user object cannot be altered if it has System Administration permission.

Which security operations use additional information from the business logic can be identified in different manners. In one implementation, they are flagged in or coded into the control module 708 so that each time the security operation is invoked the control module 708 knows to access the business logic for the additional information. Alternatively, control module 708 may communicate with the business logic for each security operation and receive an indication from the business logic of either the additional information or an indication that there is no additional information.

If additional tests are to be carried out by the control module 708, then those can be carried out prior to, subsequent to, or concurrently with the rule comparison performed by the rule comparator 706. This can result, in some situations, in the rule comparator 706 not needing to perform any rule comparison. For example, if the user ID (e.g., “Joe”) indicated in the security operation request must be the same as the user ID of the user that created the item in order for the security operation to succeed, and if the control module 708 determines that the two user IDs are not the same, then the rule comparator 706 need not check any of the rules 704 because it knows that, regardless of the rules 704, the result of the requested security operation is a fail.

Although only a single policy enforcer 702 is illustrated in FIG. 7, alternatively multiple policy enforcers 702 may be active simultaneously. The work can be distributed among multiple policy enforcers in a variety of different manners, such as where each request for security rule validation is processed by a particular policy enforcer depending upon the context of the request, the type of operation of the request, and so on.

The security policy enforcement 280 uses a layered approach that allows application developers to utilize readily understood security rules. These rules are defined in high-level concepts that are easily understood and used by developers. The rules are then mapped to specific business logic by the policy enforcer 702, which interprets the high-level terms in the context of specific business logic appropriate to the given application. This mapping and the business logic can easily be swapped out or tuned for specific instances and new mappings or business logic plugged in while allowing the application to continue to use the same high level constructs to reference the security rules. New security rules and business logic can be easily created for new applications whether in a similar problem domain or a new problem domain, and plugged into the architecture 110 as a new security policy enforcement 280. Additionally, the application can be developed rapidly utilizing the easily defined high-level rules only—the business logic need not be implemented right away. Thus, implementation can easily be done in such a manner that its delay will not hinder higher level application developers. Furthermore, this layered approach allows varying granularities of access control to be attained using one mechanism.

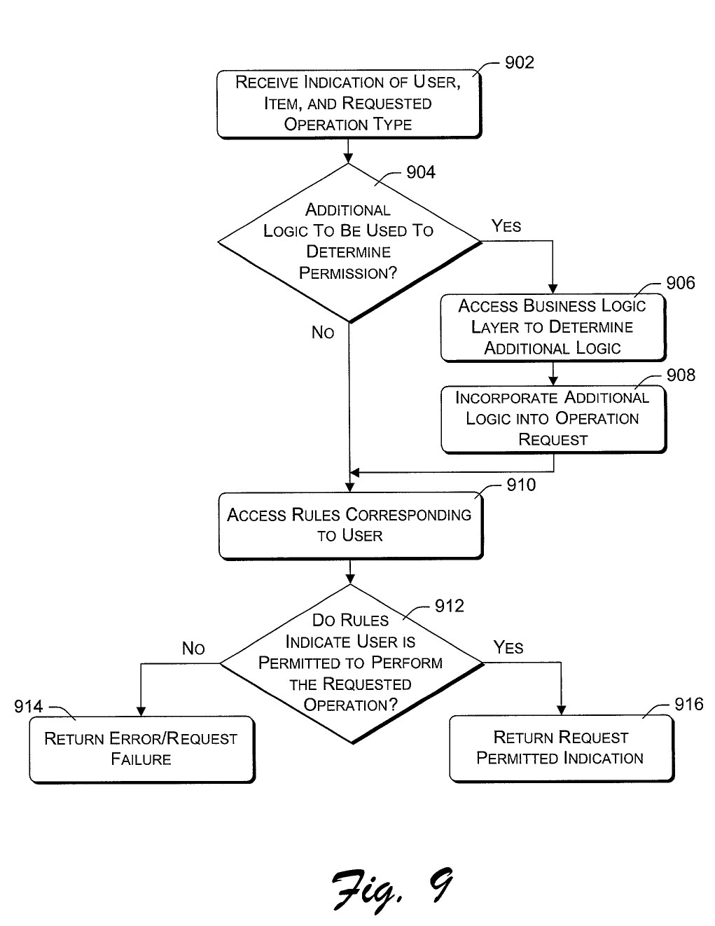

FIG. 9 shows a general operation 900 of the security policy enforcement 280 of FIG. 2. The operation 900 is implemented as a software process of acts performed by execution of software instructions. Accordingly, the blocks illustrated in FIG. 9 represent computer-readable instructions, that when executed at the server system 106 of FIG. 1, perform the acts stipulated in the blocks. FIG. 9 is discussed with additional reference to elements of FIG. 7.

At block 902, the interface 710 receives an indication of a user, an item, and a requested security operation type. As discussed above, the item can be explicitly or implicitly identified.

At block 904, the control module 708 checks whether additional logic is to be used to determine whether to return a permission grant. If additional logic is to be used, then the control module 708 accesses the business logic layer 204 of FIG. 2 to determine what that additional logic is (block 906). At block 908, the control module 708 incorporates this additional logic into the operation request. This incorporation may involve generating additional rule tests to be carried out by the rule comparator 706, or alternatively additional tests to be carried out by the control module 708.

At block 910, the rule comparator 706 accesses the rules 704 corresponding to the user. At block 912, the rule comparator 706 checks whether the rules 704 indicate that the user is permitted to perform the requested operation. If the user is not permitted to perform the requested operation, then the rule comparator 706 returns an error or request failure result (block 914). However, if the user is permitted to perform the requested operation, then the rule comparator 706 returns a request permitted (or succeed/pass) indication (block 916).

Presentation Layer

The presentation layer 212 facilitates delivery of the responses produced by the business logic layer 204 back to the client devices. The presentation layer 212 enables the server application to selectively render output based on the type of receiving device, such as web browsers, WAP devices, PDAs, and other computing devices. This layer also addresses what the “look and feel” of an application is from a brand and user-choice perspective.

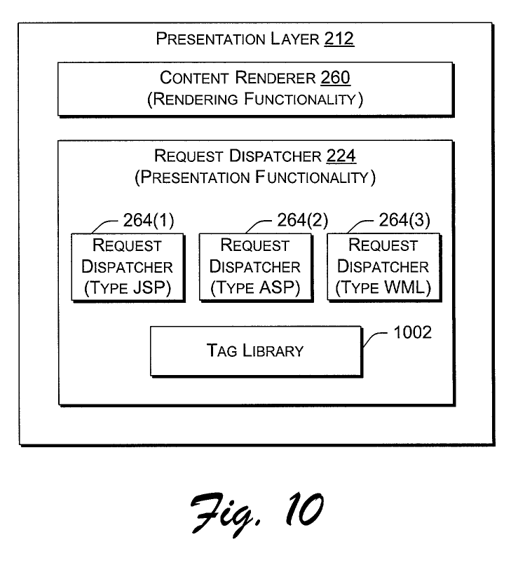

FIG. 10 illustrates the presentation layer 212 in more detail. The presentation layer 212 is itself a composite of two tiers that generally separate presentation functionality from rendering functionality. The partitioning of presentation from rendering permits developers to design separate solutions for how content is presented to users and how content is physically output to achieve that presentation.

The request dispatcher 224 implements the presentation functionality by performing any logic associated with choosing which data or content to be displayed, performing any transformations or manipulations of the data or content, and selecting an output format appropriate to the conditions, preferences, and properties of the user. For instance, the request dispatcher 224 picks which content to return in the reply to the client, such as whether the reply should include such content as branding logos (i.e., company, sponsors, etc.), advertising banners, notices, legal terms, and so on. The request dispatcher 224 selects the encoding, communication protocol, and the presentation. The presentation encompasses decisions such as where to position the various display elements, whether to use tables or charts, determination of an appropriate color scheme or the decision to impose an overall “skin” theme that dictates the color palette and appearance to the presented content. The dispatcher 224 may make such decisions and other customizations based on the capabilities of the client device, preferences of the user, and properties of the application. The request dispatcher 224 then delegates to the content renderer 260 (described below).

The request dispatcher 224 also selects the appropriate encoding format for the particular client device. For a browser-enabled client, the dispatcher may select to encode the content using HTML. If the client is a wireless communications device, perhaps the dispatcher elects to encode the content using WML (Wireless Markup Language). Other possible formats include XML (extensible markup language), EDI (electronic data interchange), etc.

Also contributing to the presentation functionality implemented by the request dispatcher 224 is the selection of an appropriate communication protocol for communicating the reply to the client. The request dispatcher may elect to use HTTP and/or TCP/IP to send the reply to the browser-enabled client. For a wireless communication device, the request dispatcher 224 may employ WAP to send the reply. Other possible protocols include Java™ RMI (Remote Method Invocation), CORBA (Common Object Request Broker Architecture), etc.

The request dispatcher 224 selects one or more request dispatcher types 264 that implement specific types of presentation functionality. As one example implementation, FIG. 10 shows three request dispatcher types 264(1), 264(2), and 264(3). The first request dispatcher type 264(1) is configured to structure replies using Java server pages (JSPs). JSP is an HTML page with embedded Java™ source code that is executed at the server system. The HTML provides the page layout that will be returned to the client's web browser, and the code provides the presentation processing to fill in the page with content. The second request dispatcher type 264(2) is configured to generate responses using Active server pages (ASP), a technology from Microsoft Corporation that allows for dynamic creation of web pages. The third request dispatcher type 264(3) is configured to generate responses using WML technology.

The request dispatcher type 264 may optionally access a tag library 1002 to retrieve preformed HTML tags for convenient and efficient construction of a response page. The tag library 1002 contains various tags that adapt to various device formats and protocols, as well as different languages. In this way, a single code base can be used to ensure a correct format for multiple languages, to selectively render output based on the type of device that is receiving the output of the application, and so forth. It is noted that the request dispatcher may rely on other modalities in place of preformed tags in a tag library. For instance, the request dispatcher type may have utilize templates to aid in constructing replies.

The presentation layer 212 further includes a content renderer 260 that implements the rendering functionality. The content renderer 260 performs any work related to the output, display, formatting, printing, etc., of the content to the user. The content renderer 260 may make logical decisions based on the content and user or system preferences, but such logical decisions are restricted to the actual rendering of the data or content. For instance, the content renderer 260 constructs the output display to accommodate the actual size of the user's display. A web page produced by the request dispatcher may be sized differently depending upon whether the page is being served to a 21″ CRT monitor for a desktop computer or to a small 4″ LCD screen for a handheld device.

The content renderer 260 may also decide how to display the content, making such decisions as whether text should be color or black and white, whether graphics can be supported, and so forth. The content renderer 260 may also manipulate font selections to ensure readability at the client device. These decisions may be based on the client device capabilities, or on user preferences. For example, a vision-impaired user may prefer larger font size than other users.

The dual-tier architecture may be implemented according to different software techniques. In one implementation, the tiers may be implemented as a proprietary protocol or an application program interface (API). For instance, an API may be used to interface the content renderer 260 and the request dispatcher types 264 with the framework-based engine 262 of the execution environment (FIG. 2). The execution environment could then make calls into the presentation and rendering tiers via the API, passing in the processed results and the any desired parameters regarding layout, color, themes, protocols, formats, and so forth. The content renderer 260 and request dispatchers 264 would then structure and return the replies in the desired form. In another implementation, the presentation layer 212 may be configured as a highly interoperable extension of an existing platform, such as the J2EE (Java 2, Enterprise Edition) platform. In this case, the presentation layer 212 could delegate certain of the rendering activities to existing technology, such as JSP, while performing the presentation functions as described.

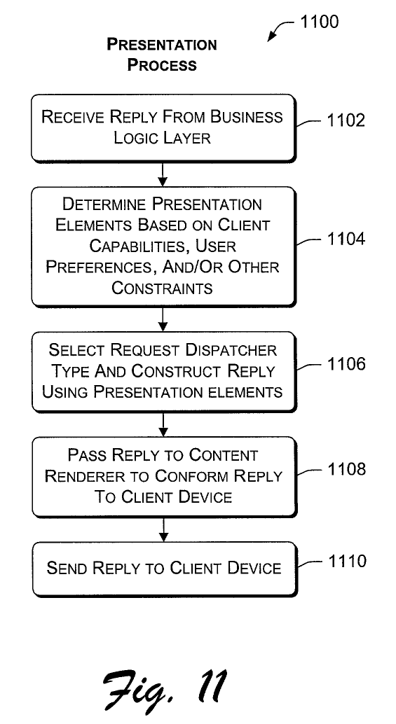

FIG. 11 shows a process 1100 for structuring replies in a presentation form that accommodates client device capabilities and user preferences. The process 1100 is implemented in software and hence, the illustrated blocks represent computer-readable instructions, that when executed at the server system 106, perform the stated acts.

At block 1102, a reply is received from the business logic layer 204. The reply is produced as a result of processing a request received from a client. At this point, the reply can be in the form of raw data being returned from the execution model 230. For instance, the reply may be a description of an asset, or a quote on a financial instrument, or a confirmation of an order, or practically anything.

The reply is received initially at the execution environment 202, which originally routed the client request to the business logic layer 202. More particularly, the reply is routed to the request dispatcher 224.

At block 1104, the request dispatcher 224 determines the presentation elements of the reply. This might include the layout, color scheme, branding logos, notices, and so forth. The determination may be based on the client capabilities, the user's preferences, and/or other constraints. Once the presentation elements are determined, the request dispatcher 224 (or more specifically, the engine 262) selects a request dispatcher type 264 to structure the reply with the presentation elements (i.e., block 1106). The request dispatcher type 264 further encodes the reply according to the desired encoding format and communication protocol for the specific client device.

At block 1108, the reply is passed to the content renderer 260, which makes any further modifications to adapt the reply for specific output at the client. For instance, the content renderer 260 might adjust size, convert from color to black and white, or make other alterations to suite different display types of the client devices. At block 1110, the properly constructed reply is returned to the client device for presentation to the user.

The tiered structure of the presentation layer is beneficial in that it allows convenient and adaptable support of multiple client types without modification of the business logic. With a tiered presentation layer, presentation functions pertaining to user preferences (e.g., color schemes, layout, etc.) can be handled independently of the specific rendering tasks demanded by client device capabilities.

Constraint Hierarchy

One beneficial aspect of the multi-layered application architecture 110 is that it can be configured to implement and enforce constraints that customize the behavior of the application. The constraints can be imposed by a variety of sources, with each source carrying a different priority. For instance, when creating an e-business application that can be accessed worldwide, there are a number of constraints that may be employed. A user may express preferences for how content is displayed. Customs of the user's locale may impose their own preferences, such as the addition of branding information and changes to icons, colors, themes, etc., to convey an overall business identity. An application service provider may require that certain disclaimers or advertising be present. Additionally, there may be legal restrictions imposed by government entities on the information that is accessible or viewable by a user of the system.

Currently, changes are made directly to application source code to implement such constraints. However, the architecture 110 can allow different constraints to be added or removed from an application independently of the business logic or other source code for the application. The architecture supports a hierarchy of constraint layers, where each constraint layer imposes different constraints on how the application might operate or how content may be presented to the user.

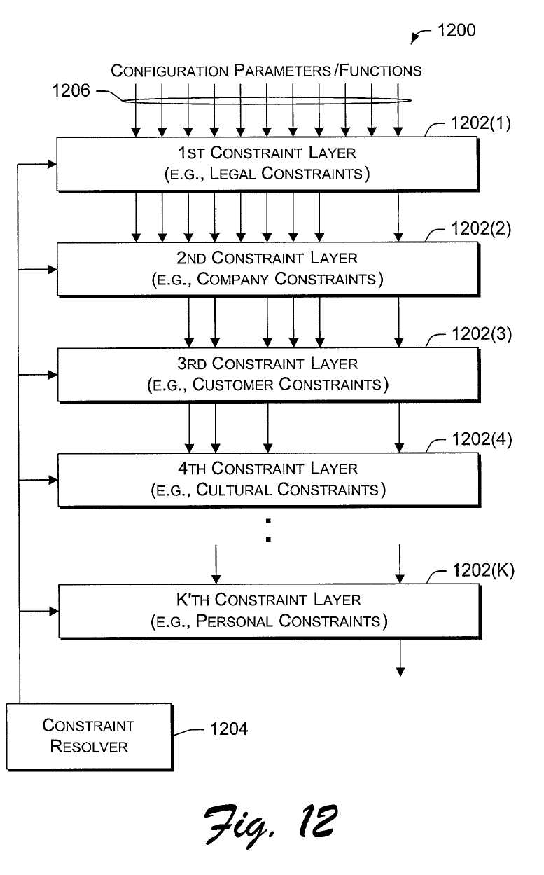

FIG. 12 shows an exemplary constraint hierarchy 1200 composed of multiple constraint layers 1202(1), 1202(2), . . . , 1202(K). Each constraint layer contains a set of constraints that are placed on various configuration parameters and application functions of the application. The constraints may be imposed from many-different sources (e.g., legal, government, company, customer, user, etc.). Hence, each constraint layer may be viewed as representing a different source that controls or customizes how the application appears or operates.

The constraint layers 1202 are organized so that higher-level constraint layers effectively limit or constrain lower-level constraint layers. For instance, the constraints imposed by top layer 1202(1) effectively carry through to all lower layers 1202(2)-1202(K). Each constraint sets forth a set of metadata specifying preferred presentation and operation functionality. For instance, the metadata might suggest preferences for how content is presented (e.g., color, images, branding, terms and conditions, etc.). The constraint metadata might also control non-presentation aspects, such as logging and auditing functions, wherein the metadata specifies types of logins utilized for different users, regions, or departments. The metadata may also act as a filter to prevent certain operations or presentation features from occurring.

A constraint resolver 1204 resolves the constraints at run time, or prior to run time, so that the application behaves and appears appropriately for the given set of constraints. With respect to presentation constraints, for example, the resolver 904 may use the metadata to identify or produce suitable tags used for coding an HTML or XML Web page in a manner that satisfies the constraint criteria. The constraint resolver 904 reconciles any conflicts among constraints imposed by different layers. In one implementation, the conflicts are resolved in favor of the higher-level layer so that constraints imposed by the higher-level layer effectively limits the lower-level layer, but not vice versa.

Once resolved, the constraint hierarchy 1200 may reside in any one of many places in the architecture 110. It may reside in the execution environment 202 or the presentation layer 212. It may further reside as a separate layer, akin to the authentication model 270 and security policy enforcement module 280. The constraint hierarchy 1200 may be implemented as a module that is readily added or removed from the architecture, perhaps as a DLL (dynamic link library) file. Alternatively, it may be a global document (e.g., an XML document) that resides remotely from the application, but is accessible by the application to determine how certain operations are to be performed for a given group of parties and conditions.

One example set of constraints is illustrated in FIG. 12. These constraints are arranged as a hierarchy of five constraint layers-legal, corporate, customer, cultural, and user. Prior to being constrained, the server application offers many different configuration parameters and application functions that may be individually selected or combined. These parameters and functions are illustrated as arrows 1206 into top constraint layer 1202(1).

In this example, the uppermost constraint layer 1202(1) contains legally mandated constraints that dictate a certain behavior based on legal issues. Suppose, for example, that the legal constraint layer 1202(1) specifies that all login pages carry a legal notice that only authorized employees and registered customers are permitted to login to the application. Due to the hierarchical nature, this legal constraint is applied to the login screen regardless of other constraints imposed by lower level constraint layers.

The second constraint layer 1202(2) contains company-mandated constraints that specify behavior appropriate for the company operating the application. Suppose that the company constraint layer specifies that all user interface screens presented to users be branded with the company's logo. When the resolver 1204 resolves the two highest constraint layers—legal and company—the application will only serve logon pages that display the legal notice and the corporate brand.

The third constraint layer 1202(3) contains customer-desired constraints that provide behavior preferred by customers of the operating company. Perhaps one customer prefers that the web pages adhere to a company color scheme of red, gold, and white. The fourth constraint layer 1202(4) contains cultural constraints that stipulate behavior mandated by the culture to which the application's user belongs. For example, one local culture might stipulate that a certain color, such as red, cannot be used in web pages because it is culturally or politically unacceptable.

The fifth constraint layer (illustrated as layer 1202(K), where K=5) contains personal user constraints that specify personal preferences. Continuing our example, suppose the user prefers that any objects and images appearing on web pages conform to a certain theme, such as a period theme (1950s or 1960s) or a topic theme (e.g., sports, travel, etc.).

The constraint resolver 1204 resolves the five constraint layers, reconciling any conflicting constraints. For instance, constraints imposed by the fifth constraint layer to accommodate user preferences are subject to constraints imposed by any of the four higher constraint layers. If a higher constraint layer imposes constraints that prevent a behavior preferred by the user (e.g., the cultural constraint layer objects to the color red, even though this color is preferred by the user), the user preference is not accommodated by the application.

Once all the constraints are resolved, pages that are generated by the application are constrained by the sum of the constraints. For example, a user in one culture may receive a logon page with the legal notice (legal constraint layer) and company logo (corporate constraint layer), depicted in gold and white colors (customer constraint layer), without the red color (cultural constraint layer), with objects and images conforming to a baseball theme (user constraint layer). All constraint layers constrained the behavior of the application when producing the resulting page that is served to the client.

One advantage of employing the constraint hierarchy is that multiple instances of the same application can behave entirely differently based on the constraint layers in place and the user's situation during interaction with the application. For instance, another user located in a different culture may receive a logon page with the legal notice (legal constraint layer) and company logo (corporate constraint layer), depicted in red, gold and white colors (customer constraint layer without being further constrained by the cultural constraint layer) and with objects and images conforming to a 1960s theme (user constraint layer). The login page would look very different, but would permit user interaction with the same underlying server application.

Accordingly, the constraint hierarchy enables many requirements and constraints from different parties and entities to be combined and affect a live application. As conditions, attitudes, preferences, and culture change, the constraint hierarchy can be modified to accommodate such changes.

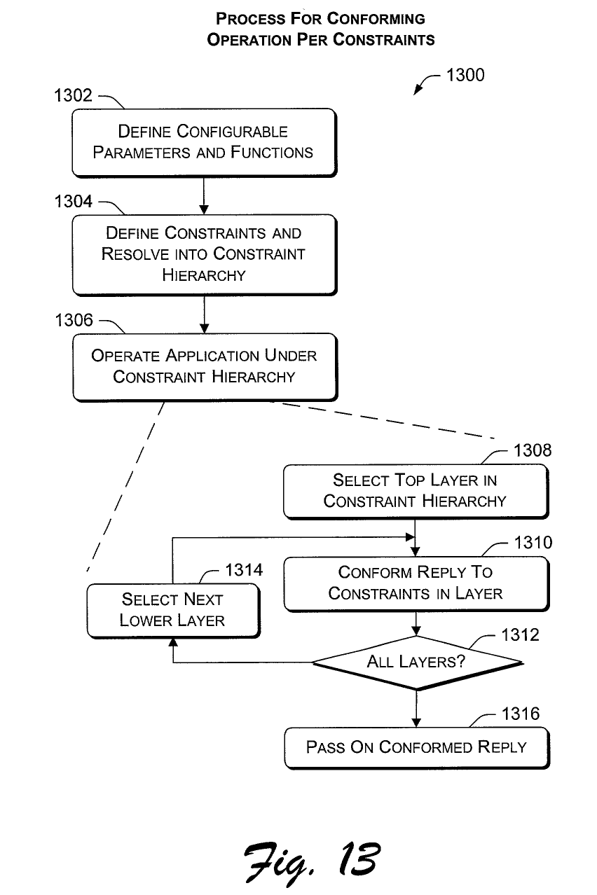

FIG. 13 shows a process 1300 for constraining operation of the application according to preferences of different groups. The process 1300 may be implemented in software as computer-readable instructions, that when executed at the server system 106, perform the acts depicted in the blocks.

At block 1302, the configurable parameters and functions of the application are defined and collected in memory. At block 1304, various constraints imposed by one or more parties to constrain the parameters and functions are resolved into a hierarchy. One exemplary hierarchy is illustrated in FIG. 12. At block 1306, the application operates under the constraint hierarchy to observe the constraints imposed by the various layers.

One exemplary operation pertaining to generating an appropriate reply according to the constraint hierarchy is illustrated as blocks 1308-1318. For discussion purposes, suppose that a reply is recently generated by the business logic and is ready to be presented back to the user. Prior to be served, however, the reply is passed through the constraint hierarchy 1200 to modify the reply according to the constraints.

At block 1308, the first layer in the hierarchy is selected for analysis. The first layer imposes certain constraints (e.g., legal constraints) to which the reply is conformed (i.e., block 1310). As one example, this conformance is achieved by attaching one or more tags or other metadata to the reply to instruct the presentation layer 212 that these certain constraints are to be observed when preparing the reply for return to the client.

The reply is evaluated against each layer in the constraint hierarchy, as represented by blocks 1312 and 1314. Once the reply is conformed to all constraint layers (i.e., the “yes” branch from block 1312), the reply is passed on to the next module in the architecture, such as the presentation layer 212 (i.e., block 1316).

Input Validation

Users are able to input requests to an application via a user interface that presents one or more forms to the user, each form having one or more data input fields (e.g., text areas, user-selectable check boxes or buttons, etc.). These data inputs are predominately referred to herein as user inputs, although the inputs can alternatively come from elsewhere (e.g., from another application or component). For many forms, the application developer desires to place restrictions on the data that can be input to the fields of the form. An automatic input validation technique is used that allows forms with input fields to be automatically generated to include input validation for one or more of the input fields. Forms can be automatically generated in any of a wide variety of languages, and in one embodiment are generated as conventional pages (documents) of a conventional markup language such as the well-known HyperText Markup Language (HTML) or the well-know eXtensible Markup Language (XML). The form itself includes the validation code and thus performs the validation at the client (referred to as client-side validation).

The automatic input validation technique described herein can be implemented in a variety of different manners. In one implementation, the automatic input validation technique is implemented as part of an application design process during which the user interface for the application is designed. This results in the form, with the automatically generated input validation, being generated prior to distribution to customers and/or users. Alternatively, the automatic input validation technique could be implemented as part of a data input process (e.g., as part of the presentation layer 212 or the business logic layer 204 of FIG. 2). In this implementation, when a user makes a request for which the application presents a form for user input, the automatic input validation technique may be used to generate a form “on the fly” for presentation to the user.

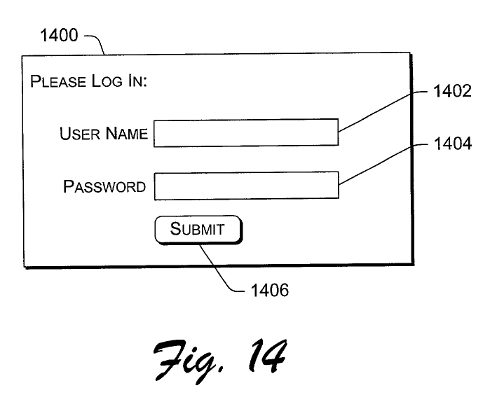

FIG. 14 illustrates an example form 1400 allowing a user to log in to a system. The form 1400 includes a user name field 1402 into which the user can enter his or her name (or other user identifier), and a password field 1404 into which the user can enter the password associated with the name entered into the field 1402. Once the user has entered both, he or she can actuate the submit button 1406 to proceed with the log on process.

As an example, assume that the designer of the form 1400 wishes to have the user inputs into the fields 1402 and 1404 restricted to certain values. These restrictions may be due to processing restrictions inherent in the business logic, or alternatively, they may be simply design choices. The designer may want the user name field 1402 to be a required field and have a maximum length of 32 characters, while the password field may be a required field having a minimum length of five characters. In order to place such restrictions on the fields 1402 and 1404, the designer of the form 1400 writes a form definition (also referred to as source code) for the form (e.g., in a text markup language) using a set of custom auto-validation tags. The custom auto-validation tag for the field 1402 indicates the data to be displayed (“user name”) and also identifies the desired restrictions. Similarly, the custom auto-validation tag for the field 1404 indicates the data to be displayed (“password”) and also identifies the desired restrictions. The following example source code illustrates an exemplary form definition written to generate the form 1400 (this form definition will be used as a basis for generating an output form definition including validation code, as discussed in more detail below):

<Custom:Form>

<Text>Please Log In:</Text>

<Custom:TextTag name=“User Name” required=“true” maxlength=“32”/>

<Custom:PasswordTag name=“Password” required=“true” minlength=“5”/>

<Custom:ButtonTag name=“Submit” type=“submit”/>

</Custom:Form>

In the above example form definition, the prefix “custom:” is used to indicate that the tag is a custom auto-validation tag (rather than a conventional tag, such as an HTML tag). The designer indicates the user name field 1402 by identifying the name to be displayed on the form 1400 (name=“User Name”), that data is required to be input in the field 1402 (required=“true”) and that the maximum number of characters that can be input to the field is 32 (maxlength=“32”). Similarly, the designer indicates the password field 1404 by identifying the name to be displayed on the form 1400 (name=“Password”), that data is required to be input in the field 1404 (required=“true”) and that the minimum number of characters that can be input to the field is 5 (minlength=“5”). No other information need be input by the designer for these fields to be restricted in this manner—the validation code to enforce these restrictions is automatically generated as discussed in more detail below.

It should be noted that, in the preceding example, the designer can also input additional tags without the “custom:” prefix. Such tags will not have any restrictions placed on them by the automatic generation process described herein, and will simply “fall through” into the final output form as discussed below.

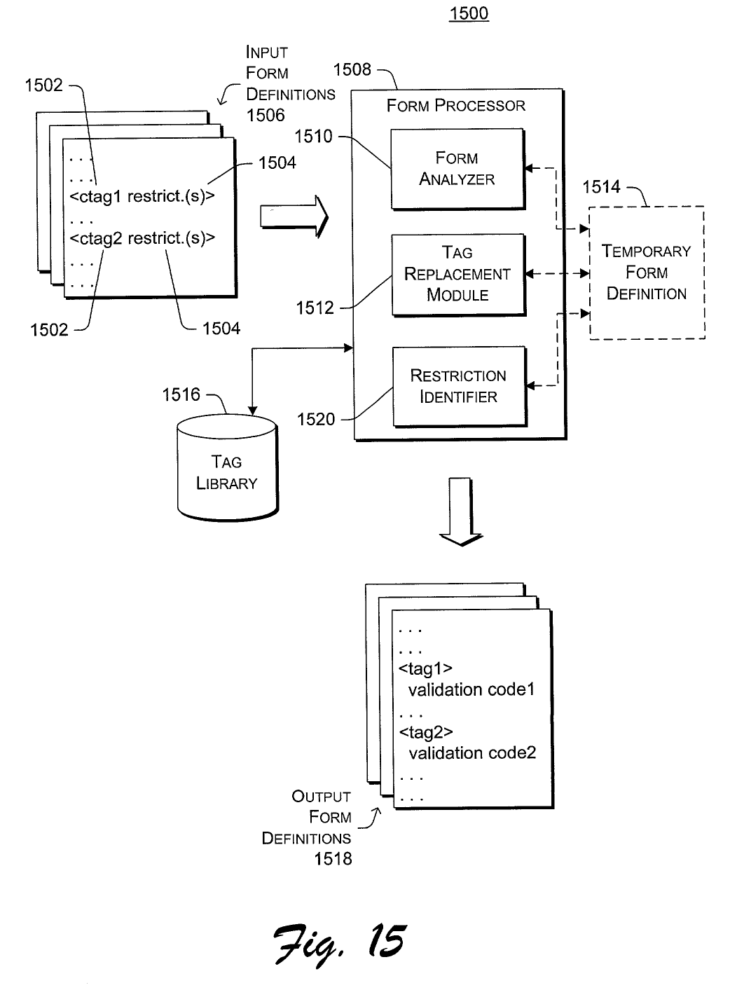

FIG. 15 illustrates an exemplary automatic form generation with input validation system 1500. One or more forms are created by a designer or programmer including an identification of which fields are to have their inputs restricted and what those restrictions are. These are referred to as the “custom” fields or tags and are illustrated as “ctags” 1502 and corresponding restrictions in the input form definitions 1506. The input form definitions 1506 are written in a source code that defines the contents of the forms. The input form definitions 1506 can be written in a variety of different formats, and in one implementation is written in the Java Server Page (JSP) format. Alternatively, the input form definitions 1506 could be written in other formats, such as Active Server Page (ASP), Personal home page Hypertext Preprocessor (PHP), and so forth.

The input form definitions 1506 are input to a form processor 1508, which includes a form analyzer module 1510 and a tag replacement module 1512. The form processor 1508 generates a temporary form definition 1514 (e.g., in system memory) that includes two components: the first component is all of the non-custom tags, which are not altered by the form processor 1508, and the second component is a replacement for each of the custom tags.

The form analyzer module 1510 analyzes the input form definition 1506 to identify the custom tags in the form definition 1506. The form analyzer 1510 adds each non-custom tag to the temporary form definition without altering the tag. The custom tags, however, are identified by the form analyzer 1510 to the tag replacement module 1512. The tag replacement module 1512 replaces the custom tags with two components: the corresponding non-custom tag and executable code to subsequently generate the validation code for the tag. Each custom tag has a corresponding non-custom tag which provides the same functionality (except for the validation) as the custom tag. In the illustrated example above where the custom tags are identified by the prefix “custom:”, the corresponding non-custom tag is generated by dropping the prefix “custom:”. Alternatively, the corresponding non-custom tag may be generated in other manners, such as looking up the corresponding tag in a mapping table, by re-arranging characters in the custom tag in some known or agreed upon manner, and so forth.

The executable code is obtained by the tag replacement module 1512 from a tag library or database 1516. The tag replacement module 1512 maintains a record of (e.g., is pre-programmed with) what executable code is to be inserted for a custom tag based on both the particular tag and the restrictions associated with the tag. In one implementation the executable code is Java code, although code written in other formats (e.g., JavaScript, Visual Basic for Applications (VBA), etc. could also be used).

Once all of the custom tags have been replaced (and the non-custom tags added to the temporary form), the executable code added by the tag replacement module 1512 is executed. Each piece of executable code added by the tag replacement module 1512 is configured to copy into the temporary form definition 1514 the validation code used to validate the corresponding tag given the associated restrictions. The generation of such validation code is well-known to those skilled in the art and thus will not be discussed further. The validation code is the code that becomes part of the output form definition 1518 and subsequently executes to validate user inputs. The validation code can be copied from the tag library 1516, or alternatively from one or more other components (e.g., another local or remote database or computer, from a data store internal to the tag replacement module 1512, etc.).

In addition to copying in the validation code for the corresponding tag, the executable code also adds in a reference to (e.g., a call to) the validation code. This reference to the validation code is associated with the corresponding tag in the temporary form and will be associated with the corresponding tag in the output form definition 1518. Thus, when data is subsequently input to the form, the reference associated with the tag allows the validation code in the form to be invoked and verify the input for the corresponding field satisfies the identified restrictions. Alternatively, the form may be designed so as to automatically run the validation code rather than requiring it to be invoked by a specific reference or call to the code.

The validation code that is added to the temporary form definition 1514 can be generic code or alternatively individualized code. If the validation code is generic code then it is provided with the values for the appropriate restriction(s) (e.g., the value of “32” for the maximum length of data input to a field) at run-time. This can be accomplished in a variety of manners, such as including the value(s) as a parameter when invoking the validation code. However, if the validation code is individualized code, then the executable code that copies in the validation code also alters the validation code to program in the restriction values (e.g., alter the validation code so that it checks whether the data input exceeds the value of “32”). Thus, in this situation the validation code is pre-programmed with the value (“32”) to be used for validating the input, rather than receiving the value (“32”) as a parameter when invoked.

The pieces of executable code added by the tag replacement module 1512 are optionally configured with intelligence to avoid duplicate validation code in the form. If two different tags have the same restrictions or types of restrictions, and thus use the same validation code, then the pieces of executable code add that validation code only once and then add, for each of the two tags, a reference to (e.g., a call to) the single piece of validation code. For example, multiple fields may have a “required” restriction so that data must be input to the field by the user. Rather than including multiple copies of the validation code that validates that data has been input into a field, a single copy of the validation code is included in the form and each field into which data must be input has a tag that references the single copy of the validation code.

By way of another example, two different fields may have a maximum length restriction but identify two different maximum lengths (e.g., one may have a maximum length of five characters and the other a maximum length of twelve characters). If individualized validation code is being used, then the two fields have different validation code (one being pre-programmed to five characters and the other to twelve characters). However, if generic validation code is used, then only one copy of the validation code that verifies that the maximum length has not been exceeded is included in the form, and that validation code receives as an input parameter the maximum length value. The reference to (e.g., call to) this validation code associated with the tag of each field passes to the validation code the maximum length value associated with the restriction on that tag (e.g., five and twelve in the above example).

After all of the executable code added by the tag replacement module 1512 has been executed, the resultant temporary form definition 1514 becomes the output form definition 1518. The output form definitions 1518 are written in a source code that defines the contents of the forms. When displayed, the component displaying the form uses this form definition to generate an interface that can be presented to a user. The output form definition 1518 is written in a conventional language (e.g., HTML or XML), and includes all of the validation code to self-validate any data input to the fields (with restrictions placed on them by the form designer). Alternatively, the output form definition 1518 could be written in any public and/or proprietary language, although this may limit the use of the form (e.g., to only those environments that understand the language the form definition 1518 is written in).

The following example form definition in Table 5 illustrates the source code for an exemplary output form definition 1518. This source code is exemplary output source code corresponding to the example input source code discussed above, and when rendered produces form 1400 of FIG. 3. Lines 1-6 define the information and data input fields displayed to the user. Line 8 identifies a JavaScript program. Lines 9-18 define various functions used to validate inputs. Lines 19-24 define the function to validate that data was input to the user name field but did not exceed 32 characters. Lines 25-30 define the function to validate that data was input to the password field and that the input was at least five characters. Lines 32-43 define variables used in the validation code. Lines 45-84 define a function for verifying that the proper number of characters (minimum and/or maximum) were input. Lines 86-88 define a function that is called (from line 5) to perform the validation when the submit input is selected by the user.

TABLE 5

| | |
|---|---|
| 1. | <FORM> |
| 2. | <TEXT>Please Log In:</TEXT> |
| 3. | <INPUT TYPE=”text” NAME=”UserName”> |
| 4. | <INPUT TYPE=”password” NAME=”Password”> |
| 5. | <INPUT TYPE=”submit” VALUE=”Submit” onSubmit=”return bValidate(this);”> |
| 6. | </FORM> |
| 7. | |
| 8. | <SCRIPT LANGUAGE=”JavaScript”> |
| 9. | function bCheckIfNotBlank(aField) { |

| | |
|---|---|
| 10. | if (!aField.value) return false; |
| 11. | else return true; |

| | |
|---|---|
| 12. | } |
| 13. | function bIsGELength(aObject, nSize) { |

| | |
|---|---|
| 14. | return aObject.value.length >= nSize; |

| | |
|---|---|
| 15. | } |
| 16. | function bIsLELength(aObject, nSize) { |

| | |
|---|---|
| 17. | return aObject.value.length <= nSize; |

| | |
|---|---|
| 18. | } |
| 19. | function bValidateTextTagUserName(aForm) { |

| | |
|---|---|
| 20. | if (!(bCheckIfNotBlank(aForm.UserName))) { |

| | |
|---|---|
| 21. | aForm.UserName.focus( ); |
| 22. | return bFormShowError(‘UserName’, null, ‘Text’, ‘Y’, null, 32, null, null, null,“”); |

| | |
|---|---|
| 23. | } |

| | |
|---|---|
| 24. | } |
| 25. | function bValidatePasswordTagTagPassword(aForm) { |

| | |
|---|---|
| 26. | if (!(bCheckIfNotBlank(aForm.Password))) { |

| | |
|---|---|
| 27. | aForm.UserName.focus( ); |
| 28. | return bFormShowError(‘Password’, null, ‘Text’, ‘Y’, 5, null, null, null, null,“”); |

| | |
|---|---|
| 29. | } |

| | |
|---|---|
| 30. | } |
| 31. | # |
| 32. | # For bFormShowError |
| 33. | # |
| 34. | # nm = Name |
| 35. | # lb = Label for field, otherwise uses name |
| 36. | # ty = Type |
| 37. | # rq = Required |
| 38. | # If ty = Text, mi = minlength, else mi = minimum value |
| 39. | # If ty = Text, ma = maxlength, else mi = maximum value |
| 40. | # vc = Valid characters |
| 41. | # ic = Invalid characters |
| 42. | # pat = Pattern |
| 43. | # pt = Prompt |
| 44. | # |
| 45. | bFormShowError=\nfunction bFormShowError(nm, lb, ty, rq, mi, ma, vc, ic, pat, pr)\n\ |
| 46. | {\n\ |
| 47. | var t = “DATA ERROR:\\n\\n”;\n\ |
| 48. | t += “An error has occurred checking the following field...\\n\\n”;\n\ |
| 49. | t += “Field: “;\n\ |
| 50. | if (lb == null \|\| lb.length == 0)\n\ |
| 51. | t += nm;\n\ |
| 52. | else\n\ |
| 53. | t += bPlainText(lb);\n\ |
| 54. | t += “\\n”;\n\ |
| 55. | if (ty != null && ty.length > 0)\n\ |

| | |
|---|---|
| 56. | t += “Type: “ + ty + “\\n”;\n\ |

| | |
|---|---|
| 57. | if (rq != null && rq.length > 0)\n\ |

| | |
|---|---|
| 58. | t += “Required: “ + rq + “\\n”;\n\ |

| | |
|---|---|
| 59. | if (mi != null)\n\ |
| 60. | {\n\ |
| 61. | if (ty == “Text”)\n\ |

| | |
|---|---|
| 62. | t += “Min length: “ + mi + “\\n”;\n\ |

| | |
|---|---|
| 63. | else\n\ |

| | |
|---|---|
| 64. | t += “Min value: “ + bPlainText(mi) + “\\n”;\n\ |

| | |
|---|---|
| 65. | }\n\ |
| 66. | if (ma != null)\n\ |
| 67. | {\n\ |
| 68. | if (ty == “Text”)\n\ |

| | |
|---|---|
| 69. | t += “Max length: “ + ma + “\\n”;\n\ |

| | |
|---|---|
| 70. | else\n\ |

| | |
|---|---|
| 71. | t += “Max value: “ + bPlainText(ma) + “\\n”;\n\ |

| | |
|---|---|
| 72. | }\n\ |
| 73. | if (vc != null && vc.length > 0)\n\ |
| 74. | t += “Allowed characters: “ + bPlainText(vc) + “\\n”;\n\ |
| 75. | if (ic != null && ic.length > 0)\n\ |
| 76. | t += “Disallowed characters: “ + bPlainText(ic) + “\\n”;\n\ |
| 77. | if (pat != null && pat.length > 0)\n\ |
| 78. | t += “Pattern(s): “ + bPlainText(pat) + “\\n”;\n\ |
| 79. | if (pr != null && pr.length > 0)\n\ |
| 80. | t += “Prompt: “ + bPlainText(pr) + “\\n”;\n\ |
| 81. | t += “\\nPlease correct the data before re-submitting the form.”\n\ |
| 82. | alert(t);\n\ |
| 83. | return false;\n\ |
| 84. | }\n |
| 85. | |
| 86. | function bValidate(this) { |

| | |
|---|---|
| 87. | bValidateTextTagUserName(this); bValidatePasswordTagPassword(this); |

| | |
|---|---|
| 88. | } |
| 89. | </SCRIPT> |

In one implementation, the form processor 1508 comprises a Java compiler. The input form definitions 1506 are Java Server Pages that are compiled by the Java compiler 1508 into Java code, resulting in the temporary form definition 1514 having replaced custom tags and inserted executable Java code. The Java code is then executed, which operates to output, as the output definitions 1518, the form definition including the non-custom tags (those that were originally non-custom as well as the custom tags converted to non-custom tags), and the validation code.

Alternatively, a non-Java-oriented programming technique may be used as the form processor 1508. For example, the form processor 1508 may be a separate component or module (e.g., software, firmware, and/or hardware) that analyzes the form definitions 1506 to identify the custom tags. These custom tags are then replaced with the corresponding HTML code, validation code, and optionally a call to the corresponding validation code.

Thus, this automatic form generation with input validation can reduce the time required for designers to develop forms having input validation. The validation code that is automatically added to the forms is initially tested before being made available to the form processor 1508, so subsequent testing is not necessary regardless of how many forms it is copied to. Furthermore, the designer is alleviated of the burden of writing his or her own validation code—all that the designer needs to be concerned with is identifying what restrictions he or she desires.

A wide variety of custom tags can be used with the automatic form generation with input validation described herein, and can be used to generate forms with a wide variety of different data input fields. The following tables illustrate an exemplary set of such custom tags. These exemplary tags are described as being implemented using object-oriented programming objects, and the restrictions on tags are input as attributes for the objects. Alternatively, the tags can be implemented in other manners, such as using the restrictions as parameters when calling conventional procedures or functions.

Custom Form Tag

The custom form tag extends the HTML form tag by providing automated form validation creation. This tag also supports existing HTML form tag attributes. The custom form tag is illustrated in Table 6.

TABLE 6

| | | Required/ | |
|---|---|---|---|
| Attribute | Type | Optional | Description |
| encodingType | String | optional | This attribute is used if creating forms |
| | | | with a different encoding type, used for |
| | | | the ENCTYPE attribute that gets output |
| | | | in the <FORM></FORM> tag |
| method | String | optional | This attribute determines which HTTP |
| | | | method will be used to pass the data to |
| | | | the program. Which method to use |
| | | | depends on the program that processes |
| | | | the incoming data. The valid values are |
| | | | “GET” and “POST” and the default |
| | | | value is “POST”. |
| name | String | required | This attribute represents the HTML |
| | | | form name. |
| action | String | optional | This attribute represents the HTML |
| | | | form action. A valid URL is used. |
| onReset | String | optional | This attribute represents a JavaScript |
| | | | function name. When the reset button is |
| | | | clicked, this JavaScript function will be |
| | | | executed. This function already exists |
| | | | on the page if this attribute is specified. |
| onSubmit | String | optional | This attribute represents a JavaScript |
| | | | function name. When the submit button |
| | | | is clicked, this JavaScript function will |
| | | | be executed. This function already |
| | | | exists on the page if this attribute is |
| | | | specified. Using this tag library, a |
| | | | validation function will be built |
| | | | automatically for a given form from the |
| | | | tags and attributes specified for each of |
| | | | the form elements. When the form gets |
| | | | submitted the following processing will |
| | | | occur: |
| | | | 1) The form validation function built |
| | | | automatically by the tag library will be |
| | | | called to validate the contents of the |
| | | | form. This will return a value of true or false. |
| | | | 2) If form validation from Step 1) |
| | | | passes, and the onSubmit value is not |
| | | | null, the JavaScript function referenced |
| | | | in onSubmit will be called. This |
| | | | function is built by the user and can |
| | | | return true or false depending on the |
| | | | processing that occurs within the |
| | | | function. |
| onValidate | String | optional | This attribute represents a JavaScript |
| | | | function name. When the submit button |
| | | | is clicked, this JavaScript function will |
| | | | be executed in place of the form |
| | | | validation function that would have |
| | | | been built by the tag library. This |
| | | | function already exists on the page if |
| | | | this attribute is specified. |
| | | | This function is used to validate the |
| | | | contents of the form and returns a value |
| | | | of true or false. |
| locale | Locale | optional | Locale used to retrieve localized |
| | | | resources properly. |
| target | String | optional | Target frame in which to post form to. |

Custom Button Tag

This tag creates a button that the user can push. The custom button tag is illustrated in Table 7.

TABLE 7

| | | Required/ | |
|---|---|---|---|
| Attribute | Type | Optional | Description |
| displayLabel | String | optional | Reserved for future use. |
| errorLabel | String | optional | Label that will be used to |
| | | | identify the form item |
| | | | in an error message |
| focusMessage | String | optional | Message to be displayed in |
| | | | the status area of the |
| | | | browser when this item |
| | | | receives focus |
| required | Boolean | optional | If this attribute is specified, |
| | | | a button must be pushed. |
| | | | The default is false. |
| name | String | required | Takes java.lang.String. The UI |
| | | | control name - field |
| | | | name used to indicate the |
| | | | field identity to the user in |
| | | | a human-readable form. |
| onClick | String | optional | This attribute represents a |
| | | | JavaScript function name. |
| | | | When the button is clicked, |
| | | | this JavaScript function |
| | | | will be executed. This |
| | | | function already exists |
| | | | on the page if this attribute |
| | | | is specified. |
| type | String | optional | Type of button, either: |
| | | | button, reset, or submit. |
| | | | The default value is button. |
| value | String | optional | The field value. This is |
| | | | the label used for |
| | | | the button. |
| locale | Locale | optional | Locale used to retrieve |
| | | | localized resources |
| | | | properly |

Custom Checkbox Tag

Creates a checkbox. The checkbox can be used for simple Boolean attributes, or for attributes that can take multiple values at the same time. The latter is represented by several checkbox fields with the same name and a different value attribute. Each checked checkbox generates a separate name/value pair in the submitted data, even if this results in duplicate names. The custom checkbox tag is illustrated in Table 8.

TABLE 8

| | | Required/ | |
|---|---|---|---|
| Attribute | Type | Optional | Description |
| checked | Boolean | optional | Indicates whether or not the |
| | | | checkbox is initially checked. |
| | | | Default value is false. |
| displayLabel | String | optional | Reserved for future use. |
| errorLabel | String | optional | Label that will be used |
| | | | to identify the form |
| | | | item in an error message |
| focusMessage | String | optional | Message to be displayed |
| | | | in the status area of the |
| | | | browser when this item |
| | | | receives focus |
| required | Boolean | optional | If this attribute is |
| | | | specified, a checkbox |
| | | | must be checked. The |
| | | | default is false. |
| name | String | required | The UI control name. |
| onClick | String | optional | This attribute represents |
| | | | a JavaScript function name. |
| | | | When the checkbox is clicked, |
| | | | this JavaScript function will |
| | | | be executed. This function |
| | | | already exists on the page if |
| | | | this attribute is specified. |
| onValidate | String | optional | A JavaScript function name. |
| | | | This custom JavaScript function |
| | | | is executed for validating this |
| | | | input field. If this option is |
| | | | specified, it is executed after |
| | | | the built in validation function |
| | | | has executed. The built-in |
| | | | validation function is created |
| | | | automatically based on the tags |
| | | | present in the form, and the |
| | | | properties set for these tags. |
| locale | Locale | optional | Locale used to retrieve |
| | | | localized resources properly |
| value | String | optional | The field value. |

Custom File Tag

This tag provides a mechanism for users to attach a file to the form's contents. For this TYPE the value the user enters is not sent to the server but this value is used as the filename of the file that is sent instead. The enctype attribute on the form will be set to enctype=“multipart/form-data” because the data sent to the server consists or more than one part. The custom file tag is illustrated in Table 9.

TABLE 9

| | | Required/ | |
|---|---|---|---|
| Attribute | Type | Optional | Description |
| displayLabel | String | optional | Reserved for future use. |
| errorLabel | String | optional | Label that will be used to |
| | | | identify the form item |
| | | | in an error message |
| focusMessage | String | optional | Message to be displayed |
| | | | in the status area of the |
| | | | browser when this item |
| | | | receives focus |
| locale | Locale | optional | Locale used to retrieve |
| | | | localized resources properly |
| name | String | required | The UI control name. |
| onChange | String | optional | String as an attribute. This |
| | | | attribute represents a JavaScript |
| | | | function name. When the focus |
| | | | is lost from the form element, |
| | | | this JavaScript function will |
| | | | be executed. This function must |
| | | | already exist on the page if |
| | | | this attribute is specified. |
| onValidate | String | optional | String as an attribute. This |
| | | | attribute represents a JavaScript |
| | | | function name. To validate this |
| | | | form element, this JavaScript |
| | | | function will be executed if a |
| | | | value is present for the attribute. |
| | | | This function must already exist |
| | | | on the page if this attribute |
| | | | is specified. |
| required | Boolean | optional | If this attribute is specified, |
| | | | a file must be attached to |
| | | | the form. The default is |
| | | | false. |
| value | String | optional | If this attribute is specified, |
| | | | it represents a default file |
| | | | that the form expects from |
| | | | the user's machine. |

Custom Hidden Tag

Hidden fields provide a mechanism for servers to store state information with a form. This will be passed back to the server when the form is submitted, using the name/value pair defined by the corresponding attributes. This is a work around for the statelessness of HTTP. The custom hidden tag is illustrated in Table 10.

TABLE 10

| | | Required/ | |
|---|---|---|---|
| Attribute | Type | Optional | Description |
| name | String | required | The UI control name. |
| onValidate | String | optional | A JavaScript function name. This |
| | | | custom JavaScript function is executed |
| | | | for validating this input field. If this |
| | | | option is specified, it is executed after |
| | | | the built in validation function has |
| | | | executed. The built-in validation |
| | | | function is created automatically based |
| | | | on the tags present in the form, and the |
| | | | properties set for these tags. |
| value | String | optional | The field value. |

Custom ImageInput Tag

Outputs the proper code to create an input button for a form from a given resource ID. The custom image input tag is illustrated in Table 11.

TABLE 11

| | | Required/ | |
|---|---|---|---|
| Attribute | Type | Optional | Description |
| imageResourceID | String | required | Image resource identifier |
| locale | Locale | optional | Locale to retrieve the |
| | | | proper image |

Custom Password Tag

Creates a single line text field which will not show the contents of the field but instead a masking character (e.g., the * character). The custom password tag is illustrated in Table 12.

TABLE 12

| | | Required/ | |
|---|---|---|---|
| Attribute | Type | Optional | Description |
| displayLength | String | optional | Specifies the display size |
| | | | for the text field. |
| displayLabel | String | optional | Reserved for future use. |
| errorLabel | String | optional | Label that will be used to |
| | | | identify the form item in |
| | | | an error message |
| focusMessage | String | optional | Message to be displayed in |
| | | | the status area of the |
| | | | browser when this item |
| | | | receives focus |
| locale | Locale | optional | Locale used to retrieve |
| | | | localized resources |
| | | | properly |
| maxLength | String | optional | The maximum length of text |
| | | | the user can enter. Is |
| | | | a valid integer value. |
| minLength | String | optional | The minimum length of |
| | | | text the user can enter. |
| | | | Is a valid integer value. |
| name | String | required | The UI control name. |
| onBlur | String | optional | This attribute represents |
| | | | a JavaScript function |
| | | | name. When the focus is |
| | | | lost from the form element, |
| | | | this JavaScript function will |
| | | | be executed. This function |
| | | | already exists on the |
| | | | page if this attribute is |
| | | | specified. |
| onValidate | String | optional | A JavaScript function name. |
| | | | This custom JavaScript |
| | | | function is executed for |
| | | | validating this input field. |
| | | | If this option is specified, |
| | | | it is executed after the |
| | | | built in validation function |
| | | | has executed. The built-in |
| | | | validation function is created |
| | | | automatically based on the tags |
| | | | present in the form, and the |
| | | | properties set for these tags. |
| regexp | String | optional | This is a regular expression that |
| | | | will be used to validate whether |
| | | | or not a given text input field |
| | | | conforms to a specific format |
| | | | given by the regular expression. |
| required | Boolean | optional | If this attribute is specified, |
| | | | a password must be entered. |
| | | | The default is false. |
| value | String | optional | The field value |

Custom Radio Tag

Creates a radio button. The radio button tag can be used for attributes which can take a single value from a set of alternatives. Each radio button field in the group is given the same name. Radio buttons require an explicit value attribute. Only the checked radio button in the group generates a name/value pair in the submitted data. The custom radio tag is illustrated in Table 13.

TABLE 13

| | | Required/ | |
|---|---|---|---|
| Attribute | Type | Optional | Description |
| displayLabel | String | optional | Reserved for future use. |
| errorLabel | String | optional | Label that will be used to |
| | | | identify the form item |
| | | | in an error message |
| focusMessage | String | optional | Message to be displayed in |
| | | | the status area of the browser |
| | | | when this item receives focus |
| locale | Locale | optional | Locale used to retrieve |
| | | | localized resources properly |
| name | String | required | The UI control name. |
| onClick | String | optional | This attribute represents a |
| | | | JavaScript function name. |
| | | | When the radio button is |
| | | | selected, this JavaScript |
| | | | function will be executed. |
| | | | This function already exists |
| | | | on the page if this attribute |
| | | | is specified. |
| onValidate | String | optional | A JavaScript function name. |
| | | | This custom JavaScript function |
| | | | is executed for validating this |
| | | | input field. If this option is |
| | | | specified, it is executed after |
| | | | the built in validation function |
| | | | has executed. The built-in |
| | | | validation function is created |
| | | | automatically based on the tags |
| | | | present in the form, and the |
| | | | properties set for these tags. |
| required | Boolean | optional | If this radio button is |
| | | | required to be selected. |
| | | | Default is false. |
| selected | Boolean | optional | If this radio button is |
| | | | initially checked. |
| | | | Default is false. |
| value | String | required | The field value |

Custom Select Tag

This tag lets you create a listbox as an input field on a form. It is valid inside the form tag. The possible choices of the listbox are created with the option tag. The custom select tag is illustrated in Table 14.

TABLE 14

| | | Required/ | |
|---|---|---|---|
| Attribute | Type | Optional | Description |
| childMenuName | String | optional | Specifies the name of another |
| | | | select list that exists on the |
| | | | page. If it is specified, code |
| | | | is generated automatically for |
| | | | the onChange event in the parent |
| | | | menu to “tie” the two |
| | | | select menus together. |
| deleteFirst | Boolean | optional | Indicates whether or not the |
| | | | first item in the menu specified |
| | | | by the “childmenu” |
| | | | attribute should be deleted |
| | | | when the values are changed |
| | | | in that menu. |
| displayLabel | String | optional | Reserved for future use. |
| errorLabel | String | optional | Label that will be used to |
| | | | identify the form item in an |
| | | | error message |
| focusMessage | String | optional | Message to be displayed in |
| | | | the status area of the browser |
| | | | when this item receives |
| | | | focus |
| ignoreFirst | Boolean | optional | If this optional is set to |
| | | | false and the required attribute |
| | | | is set to true, the SelectTag |
| | | | will generate the proper |
| | | | Client Side JavaScript (CSJS) |
| | | | validation code to make sure |
| | | | that an option, other than the |
| | | | first option in the list, is |
| | | | selected. The default value |
| | | | for this option is true meaning |
| | | | that the first option in the |
| | | | select list is treated as a |
| | | | valid option. |
| locale | Locale | optional | Locale used to retrieve |
| | | | localized resources properly |
| name | String | optional | Name of the select list object |
| onChange | String | optional | This attribute represents a |
| | | | JavaScript function name. When |
| | | | an item is selected, this |
| | | | JavaScript function will |
| | | | be executed. This function |
| | | | already exists on the page |
| | | | if this attribute is specified. |
| onValidate | String | optional | A JavaScript function name. |
| | | | This custom JavaScript function |
| | | | is executed for validating this |
| | | | input field. If this option is |
| | | | specified, it is executed after |
| | | | the built in validation function |
| | | | has executed. The built-in |
| | | | validation function is created |
| | | | automatically based on the tags |
| | | | present in the form, and the |
| | | | properties set for these tags. |
| required | Boolean | optional | If this select object has |
| | | | to have a value selected. |
| | | | Default is false. |
| selectType | String | optional | Either “single” or |
| | | | “multiple” to indicate |
| | | | if the select list can handle |
| | | | only a single or multiple |
| | | | selections, respectively. |
| size | String | optional | Number of items to initially |
| | | | display in the select list |
| value | String | optional | The field value |

Custom Option Tag

Used to generate an option for an option list. Typically the label is displayed to the user while the value is the data captured by a selection. The custom option tag is illustrated in Table 15.

TABLE 15

| | | Required/ | |
|---|---|---|---|
| Attribute | Type | Optional | Description |
| label | String | required | The label that will be used |
| | | | for the item. |
| name | String | optional | Not used. Instead, the label |
| | | | attribute is used as the |
| | | | text between the |
| | | | <OPTION></OPTION> tags |
| selected | Boolean | optional | Indicates if this option is |
| | | | initially selected. |
| value | String | optional | The field value. If no value |
| | | | is specified, the value field |
| | | | is replaced with the empty |
| | | | string. |

Custom Text Tag

Define a single-line text field in a form. The user can enter text inside this field. The custom text tag is illustrated in Table 16.

TABLE 16

| | | Required/ | |
|---|---|---|---|
| Attribute | Type | Optional | Description |
| displayLength | String | optional | Specifies the display size |
| | | | for the text field. |
| displayLabel | String | optional | Reserved for future use. |
| errorLabel | String | optional | Label that will be used |
| | | | to identify the form item |
| | | | in an error message |
| focusMessage | String | optional | Message to be displayed in |
| | | | the status area of the |
| | | | browser when this item |
| | | | receives focus |
| locale | Locale | optional | Locale used to retrieve |
| | | | localized resources |
| | | | properly |
| maxLength | String | optional | Specifies the maximum |
| | | | size for text in the |
| | | | text field. |
| minLength | String | optional | Specifies the maximum |
| | | | size for text in the |
| | | | text field. |
| maxValue | String | optional | Specifies the maximum |
| | | | value for an input field |
| | | | of a typed input such as |
| | | | float, integer, or price. |
| minValue | String | optional | Specifies the minimum value |
| | | | for an input field of a |
| | | | typed input such as float, |
| | | | integer, or price. |
| name | String | required | The UI control name |
| onBlur | String | optional | This attribute represents |
| | | | a JavaScript function name. |
| | | | When the text field loses |
| | | | focus, this JavaScript |
| | | | function will be executed. |
| | | | This function already |
| | | | exists on the page if this |
| | | | attribute is specified. |
| onValidate | String | optional | A JavaScript function name. |
| | | | This custom JavaScript |
| | | | function is executed for |
| | | | validating this input field. |
| | | | If this option is specified, |
| | | | it is executed after the |
| | | | built in validation function |
| | | | has executed. The custom function |
| | | | exists on the page. The |
| | | | built-in validation function |
| | | | is created automatically based |
| | | | on the tags present in the |
| | | | form, and the properties set |
| | | | for these tags. |
| regexp | String | optional | This is a regular expression |
| | | | that will be used to validate |
| | | | whether or not a given text |
| | | | input field conforms to a |
| | | | specific format given by the |
| | | | regular expression. |
| required | Boolean | optional | If this attribute is specified, |
| | | | a string must be entered |
| | | | in the input field box. |
| | | | The default is false. |
| type | String | optional | Valid values include “date”, |
| | | | “decimal”, “signeddecimal”, |
| | | | “email”, “integer”, |
| | | | “signedinteger”, “price”, |
| | | | “text”, and “year”. |
| | | | The default value is “text”. |
| value | String | optional | The field value |

Custom TextArea Tag

Define a multiline text field in a form. The user can enter text inside this field. The custom text area tag is illustrated in Table 17.

TABLE 17

| | | Required/ | |
|---|---|---|---|
| Attribute | Type | Optional | Description |
| cols | String | required | Set the number of columns |
| | | | the text window will occupy |
| | | | on the screen. |
| displayLabel | String | optional | Reserved for future use. |
| errorLabel | String | optional | Label that will be used |
| | | | to identify the form item |
| | | | in an error message |
| focusMessage | String | optional | Message to be displayed |
| | | | in the status area of the |
| | | | browser when this item |
| | | | receives focus |
| locale | Locale | optional | Locale used to retrieve |
| | | | localized resources properly |
| maxLength | String | optional | Specifies the maximum size |
| | | | for text in the text area. |
| minLength | String | optional | Specifies the minimum length |
| | | | for text in the text area. |
| name | String | required | UI control name. |
| onBlur | String | optional | This attribute represents a |
| | | | JavaScript function name. When |
| | | | the textarea loses focus, |
| | | | this JavaScript function will |
| | | | be executed. This function |
| | | | already exists on the page if |
| | | | this attribute is specified. |
| onValidate | String | optional | A JavaScript function name. |
| | | | This custom JavaScript |
| | | | function is executed for |
| | | | validating this input field. |
| | | | If this option is specified, |
| | | | it is executed after the built |
| | | | in validation function has executed. |
| | | | The custom function exists on the |
| | | | page. The built-in validation |
| | | | function is created automatically |
| | | | based on the tags present |
| | | | in the form, and the properties |
| | | | set for these tags. |
| required | Boolean | optional | If this text area is required to |
| | | | have input. Default is false. |
| rows | String | required | Set the number of rows the text |
| | | | window will show on the screen. |
| value | String | optional | The field value. |
| wrap | Boolean | optional | If text in the text area should |
| | | | wrap. The default is false. |

In one implementation, the custom tags are implemented as an object model (e.g., stored in the tag library 1516). An exemplary object model to be used by the form tags to store attributes for each input type and the overall form is illustrated in the following tables. An initial object is the FormCollection object, illustrated in Table 18:

TABLE 18
FormCollection

Vector elementList (FormItem objects)
String method
String name
String action
String onReset
String onSubmit
String onValidate
formCollection(attributes);
openForm( );
closeForm( );
addItem(FormItem item);
getItem(String name);
removeItem(String name);
outputCSJSValidation( );
delete( );

The FormCollection object is extended by the FormItem object, illustrated in Table 19:

TABLE 19
FormItem (abstract)

protected String name
protected String value
outputCSJSValidation( );
outputHTML( );
delete( );
String getName( );
String getValue( );
void setName(String name);
void setValue(String value);

The FormItem object is extended by the DisplayFormItem object, illustrated in Table 20:

TABLE 20
DisplayFormItem

String errorLabel
String focusMessage
String itemType
boolean required
outputCSJSValidation( );
outputHTML( );
String geterrorLabel( );
String getFocusMessage( );
String getItemType( );
boolean getRequired( );
void seterrorLabel(String errorLabel);
void setfocusMessage(String focusMessage);
void setItemType(String itemType);
void setRequired(boolean required);

The itemType attribute in the DisplayFormltem object is one of the following: Hidden, Text, TextArea, Password, Select, Fileupload, Radio, Checkbox, Button, or Option. This identifies another object that extends the DisplayFormItem object as illustrated in the following tables.

The TextAreaItem object is illustrated in Table 21.

TABLE 21
TextAreaItem

int cols
int maxLength
int minLength
String onBlur
String onValidate
int rows
boolean wrap
outputCSJSValidation( );
outputHTML( );

The TextItem object is illustrated in Table 22.

TABLE 22
TextItem

int displayLength
String maxValue
String minValue
String maxLength
String minLength
String onBlur
String onValidate
String regexp
String type
outputCSJSValidation( );
outputHTML( );

The HiddenItem object is illustrated in Table 23.

TABLE 23
HiddenItem

String onValidate
outputHTML( );

The PasswordItem object is illustrated in Table 24.

TABLE 24
PasswordItem

int displayLength
int maxLength
int minLength
String onBlur
String onValidate
String regexp
outputCSJSValidation( );
outputHTML( );

The FileItem object is illustrated in Table 25.

TABLE 25
FileItem

String onChange
String onValidate
outputCSJSValidation( );
outputHTML( );

The ButtonItem object is illustrated in Table 26.

TABLE 26
ButtonItem

String onClick
String type
outputCSJSValidation( );
outputHTML( );

The SelectItem object is illustrated in Table 27.

TABLE 27
SelectItem

String ownedBy
boolean deleteFirst
String name
String onChange
String onValidate
String ownedBy
boolean required
String selectType
optionList: Vector of OptionItem Objects
outputCSJSValidation( );
outputHTML( );

The OptionItem object is illustrated in Table 28.

TABLE 28
OptionItem

boolean selected
outputHTML( );

The CheckboxItem object is illustrated in Table 29.

TABLE 29
CheckboxItem

boolean checked
String onClick
String onValidate
outputCSJSValidation( );
outputHTML( );

The RadioItem object is illustrated in Table 30.

TABLE 30
RadioItem

boolean selected
String onClick
String onValidate
outputCSJSValidation( );
outputHTML( );

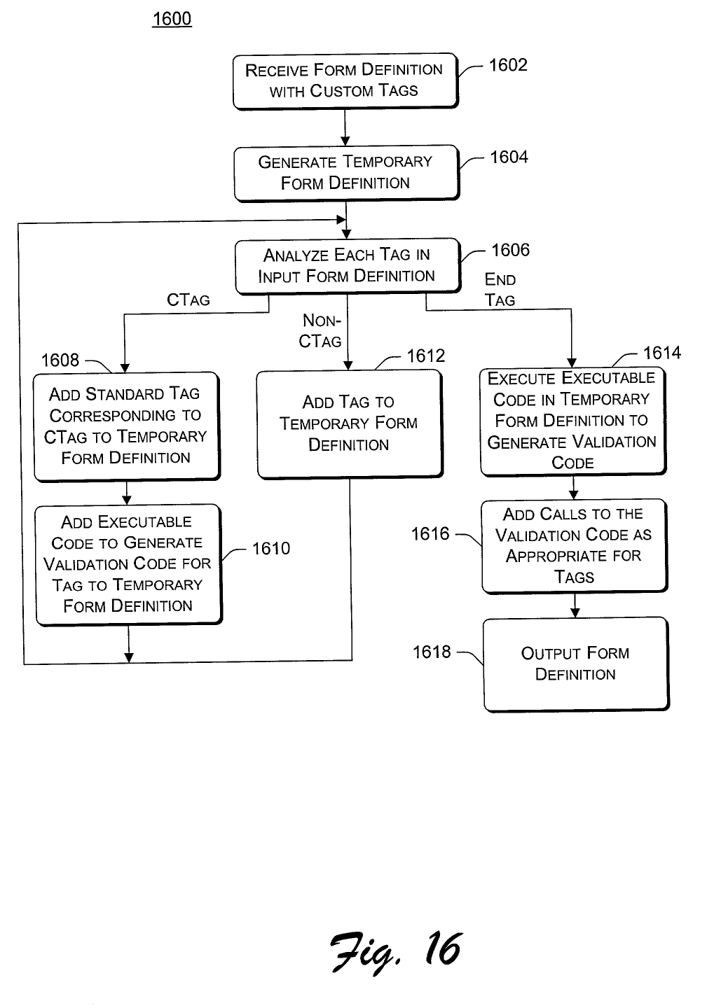

FIG. 16 is a flowchart illustrating an exemplary process 1600 for automatically generating forms with input validation. The process 1600 is implemented as a software process of acts performed by execution of software instructions. Accordingly, the blocks illustrated in FIG. 16 represent computer-readable instructions that when executed, perform the acts stipulated in the blocks.

At block 1602 an input form definition with custom tags is received, and at block 1604 a temporary form corresponding to the input form definition is generated.

At block 1606 each tag in the input form definition is analyzed and a different course of action taken depending on the tag. In the process 1600, three different tag types are possible and the process takes a different branch for each. The three tag types are: custom tag (the “ctag” branch), a non-custom tag (the “non-ctag” branch), and an end tag (the “end tag” branch).

At block 1608 (the “ctag” branch), a standard tag corresponding to the custom tag is added to the temporary form definition. At block 1610, executable code to generate validation code for the tag is added to the temporary form definition. The process then returns to block 1606 to analyze another tag. In one implementation, the tags are analyzed in the order they appear in the received input form in block 1602. Alternatively the tags may be analyzed in other orders (e.g., alternative tags, in reverse order, etc.).

At block 1612 (the “non-ctag” branch), the tag being analyzed is added to the temporary form definition. If the tag is not a custom tag then it has not been identified as having its corresponding inputs restricted, so validation code is not generated for the tag. The process then returns to block 1606 to analyze another tag.

At block 1614 (the “end tag” branch), the executable code in the temporary form definition (added from block 1610) is executed to generate the validation code. At block 1616 calls or references to the validation code are then added to the temporary form definition as appropriate for the tags (the acts of block 1616 may optionally be carried out by the executable code generating the validation code in block 1614). At block 1618, after all of the validation code has been added (block 1614) and the calls to the validation code added (block 1616), the temporary form definition is output as the output form definition.

Returning to FIG. 15, an input restriction identification module 1520 may also be included in the form processor 1508 to automatically identify contents for a form. These automatically identified form contents include fields to be included on the form and/or restrictions to be placed on inputs for fields of a form. The restriction identification module 1520 communicates with one or more of the execution models 230 in the business logic layer 204 to identify input restrictions to fields of a form as well as possibly what fields may be needed on the form. By using the communication with the business logic layer 204, the form generation process alleviates the form designer of the burden of identifying at least some of the restrictions. The form designer can thus focus on the presentation of information and be largely de-coupled from knowledge about the business logic and input restrictions. Furthermore, changes made to the input restrictions are automatically reflected in the code generated to perform the client-side validation without requiring changes to be made by the form designer (or even knowledge of the change in the restrictions on the part of the form designer).

The restriction identification module 1520 can identify restrictions on attributes from the business logic layer 204 in multiple different manners. One way in which the restriction identification module 1520 can identify restrictions on input fields from the business logic layer 204 is to have the restrictions pre-programmed into the business logic layer 204. For example, the designer of business logic in the business logic layer 204 may desire to have user ID's be no greater than 32 characters in length, and passwords to be at least five characters in length. These desires can be programmed into business logic of the business logic layer 204 so that whenever the restriction identification module 1520 requests an identification of restrictions for a “user ID” input field, the business logic returns an indication to the restriction identification module 1520 that a maximum length restriction of 32 characters is to be placed on the user ID input field. Similarly, whenever the restriction identification module 1520 requests an identification on restrictions for a “password” input field, the execution model 230 returns an indication to the restriction identification module 1520 that a minimum length restriction of five characters is to be placed on the password input field. Thus, any changes to these restrictions can be made by changing the business logic and the form designer need not have any knowledge of the changes.

The business logic may also be pre-programmed with an indication of what fields need to be included in a particular form. For example, the business logic may be pre-programmed with an indication that for a log-in form (or a form corresponding to a log-in interaction or log in request), that both a user ID field and a password field are needed, as well as what restrictions are placed on the inputs to those fields. Thus, when the restriction identification module 1520 requests an identification of fields and restrictions for a log-in form (or a log-in interaction or log-in request) from the business logic, the business logic returns an identification of both the fields to be included on the form as well as the restrictions (if any) on those forms to the restriction identification module 1518.

Alternatively, some fields and associated restrictions may be inherent in the business logic and no special pre-programming of the business logic used to list the fields and/or associated restrictions. In this situation, the restriction identification module 1520 can identify restrictions on input fields is to examine the interactions supported by the business logic of the business logic layer 204. By analyzing the interactions the restriction identification module 1520 can identify attributes used by the command definitions of the interactions and identify which of these attributes are loaded by one of the command definitions from elsewhere (e.g., a resource 108) and which of these attributes are not loaded from elsewhere. The restriction identification module 1518 identifies the attributes that are not loaded from elsewhere as attributes to be input by the user.

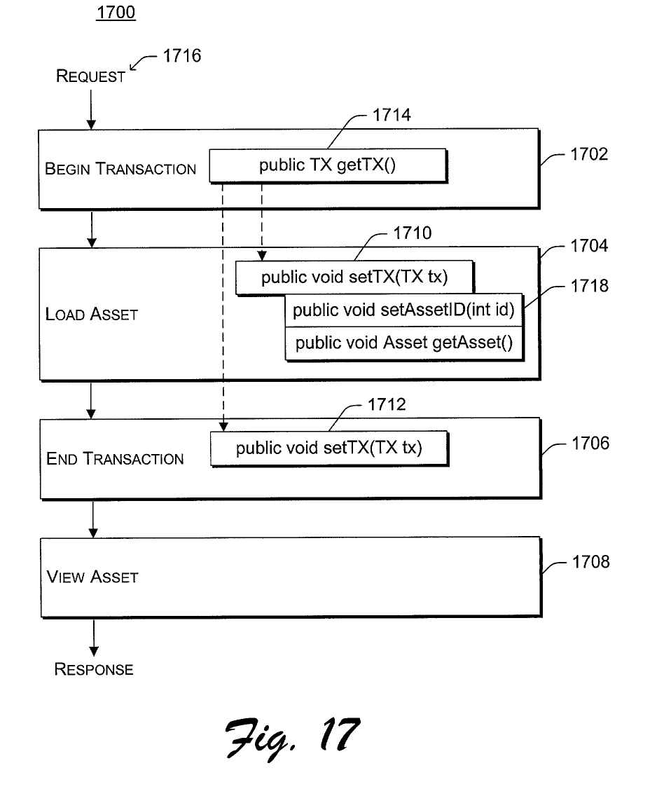

FIG. 17 illustrates an exemplary interaction 1700 that can be analyzed by the restriction identification module 1520 for identification of restrictions on input fields as well as for identification of fields themselves. The interaction 1700 is a view-asset interaction including three command definitions (begin transaction 1702, load asset 1704, and end transaction 1706) and a view definition 1708. The restriction identification module 1520 analyzes the interaction and identifies each of the methods or operations for setting an attribute. In the interaction 1700, the methods or operations for setting a attribute are defined as “set” methods. For each of these set methods, the restriction identification module 1520 analyzes the preceding definitions in the interaction to identify whether a method or operation for getting the attribute (defined as “get” methods in the interaction 1700) exists. For each attribute identified by the restriction identification module 1520 as having a set method but no preceding get method, the restriction identification module 1520 identifies that attribute as needing to be input as part of the request. The restriction identification module 1520 determines that the attribute is used in the interaction and that it is not obtained elsewhere by the interaction, so the restriction identification module 1520 presumes that the attribute is to be obtained from a form input (e.g., a user input).

For example, a “setTX” operation exists in both the load asset definition 1704 and the end transaction definition 1706 (operations 1710 and 1712, respectively). A “getTX” operation 1714 exists in the preceding begin transaction definition 1702, so the restriction identification module 1520 does not identify the “TX” attribute as being input as part of the request 1716. However, the load asset definition 1704 also includes a “setAssetID” operation 1718, and no preceding rule in the interaction 1700 includes a “getAssetID” operation. Thus, the restriction identification module 1520 identifies the “AssetID” attribute as an attribute that is to be obtained from a form input (e.g., a user input), and thus a corresponding field is to be included in the form.

Restrictions on the field input (e.g., that it is a required field) can also be identified. In one implementation, any attribute used in an interaction that is not obtained elsewhere is identified as a required input field for the form. Various other restrictions for attributes can also be identified. For example, the “setAssetID” operation 1718 indicates that the attribute is an integer (the “int” portion of operation 1718). Thus, the restriction identification module 1520 can identify that the input field is restricted to integer inputs.

The restriction identification module 1520 can use a set of rules to analyze the business logic. These rules can be programmed in to the restriction identification module 1520, or alternatively loaded into the module 1520 from another source (e.g., the business logic). A wide variety of rules can be used by module 1520. However, it is to be appreciated that the exact nature of such rules will vary depending on the specific business logic and the interactions included in the specific business logic. For example, the restriction identification module 1520 may identify an interaction in the business logic for logging into the application. The module 1520 may have a rule indicating that an attribute with the characters “password” is for a user password and has the following restrictions: it is a string, it is required, and it uses an input tag of type “password”.

In some situations, the restrictions for a data input field are not inherent in the business logic (e.g., restriction identifier 1520 may not be able to readily identify that a minimum number of input characters is a restriction for a particular field). In this situation, the form processor 1508 obtains an indication of this restriction in another manner (e.g., by information pre-programmed into the business logic, by custom tags on an input form, etc.).

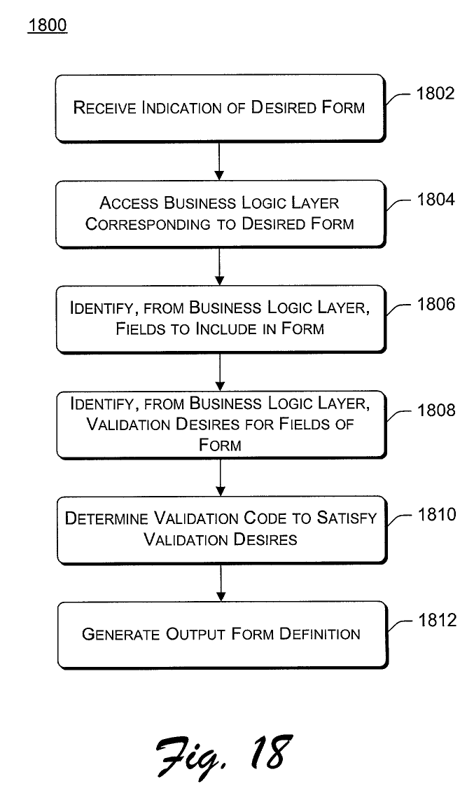

FIG. 18 is a flowchart illustrating an exemplary process 1800 for automatically identifying fields and field restrictions for forms. The process 1800 is implemented as a software process of acts performed by execution of software instructions. Accordingly, the blocks illustrated in FIG. 18 represent computer-readable instructions that when executed, perform the acts stipulated in the blocks.

At block 1802, an indication of the desired form is received. This indication identifies a type of form to be generated, such as a log-in form. The indication can be in a variety of forms, such as a request for a form by name, a request for a form corresponding to a particular interaction (e.g., a log-on interaction), etc.

At block 1804, business logic corresponding to the desired form is accessed. This business logic is, for example, one or more of the execution models 230 of the business logic layer 204 of FIG. 2.

At block 1806, fields to include in the form are identified from the business logic. As discussed above, this can be the result of analyzing the interactions and command definitions (and/or other definitions) in the accessed business logic, or alternatively by an explicit indication from the accessed business logic of the fields.

At block 1808, validation desires for fields of the form are identified from the business logic. As discussed above, this can be the result of analyzing the interactions and command definitions (and/or other definitions) in the accessed execution model(s) 230 (e.g., to identify required fields), and/or by an explicit indication from the accessed execution model(s) 230 of the validation desires.

At block 1810, validation code used to satisfy those validation desires is determined. This determination is performed by adding and subsequently executing code to generate the validation code and appropriate calls to the validation code, analogous to the discussions above regarding blocks 1610, 1614 and 1616 of FIG. 16.

At block 1812, an output form definition is generated that includes the fields identified in block 1806 and the validation code determined in block 1810. The generated output form can then be used as-is, or alternatively altered by a programmer or other application to make a more appealing presentation of the form to the user.

Alternatively, rather than outputting a generated form, an indication of the needed fields and restrictions may be returned to a form programmer. The form programmer can then manually generate tags with associated restriction information using the custom tags discussed above. He or she can then have the form submitted to the form processor 1508 for automatic generation of the form with validation code. In this situation, the validation code itself is not output by the process 1800.

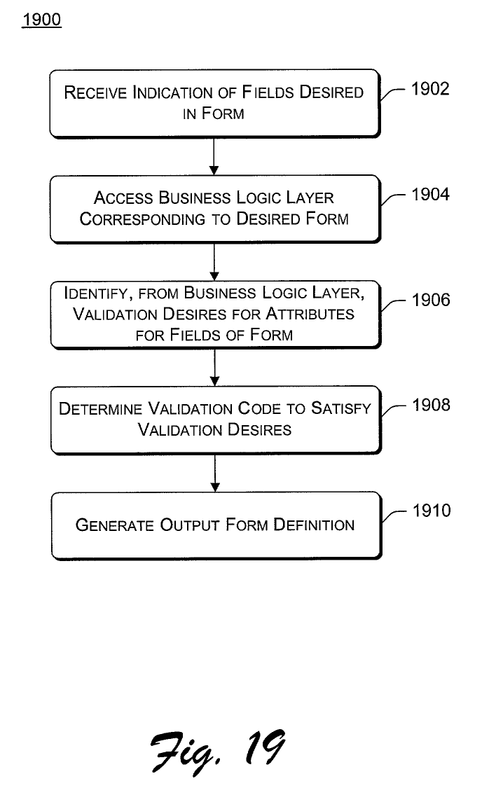

FIG. 19 is a flowchart illustrating an exemplary process 1900 for automatically identifying field restrictions for forms. The process 1900 is implemented as a software process of acts performed by execution of software instructions. Accordingly, the blocks illustrated in FIG. 19 represent computer-readable instructions that when executed, perform the acts stipulated in the blocks.

At block 1902, an indication of the fields in the desired form is received. This indication can be received in a variety of different manners, such as a listing of the fields or a form definition itself.

At block 1904, business logic corresponding to the desired form is accessed. This business logic is, for example, one or more of the execution models 230 of the business logic layer 204 of FIG. 2.

At block 1906, validation desires for fields of the form are identified from the business logic. As discussed above, this can be the result of analyzing the interactions and command definitions (and/or other definitions) in the accessed execution model(s) 230 (e.g., to identify required fields), and/or by an explicit indication from the accessed execution model(s) 230 of the validation desires.

At block 1908, validation code used to satisfy those validation desires is determined. This determination is performed by adding and subsequently executing code to generate the validation code and appropriate calls to the validation code, analogous to the discussions above regarding blocks 1610, 1614 and 1616 of FIG. 16.

At block 1910, an output form definition is generated that includes the validation code determined in block 1908. The generated output form can then be used as-is, or alternatively altered by a programmer or other application to make a more appealing presentation of the form to the user. Alternatively, rather than outputting a generated form, an indication of the needed restrictions may be returned to a form programmer analogous to the discussion of block 1812 above.

The automatic form generation with input validation described herein is predominately described with reference to client-side execution (e.g., client-side JavaScript code). This client-side execution refers to the form that is being filled in by the user (e.g., the form 1400 of FIG. 14) including executable code. Thus, the validation code can be executed at the client where the input is taking place, rather than requiring communication back to the server. In alternate embodiments, however, some or all of the client-side executable code could be replaced with code to be executed at a server(s).

Additionally, the automatic form generation with input validation described herein is predominately described with reference to generating a new form definition based on an input form definition. Alternatively, rather than generating another form definition, the content of the input form definition could itself be changed (e.g., tags changed on the input form definition and validation code added to the input form definition).

Internationalization of Application

The architecture 110 is adaptable to many different cultures, languages, and regions of the world. This adaptability is particularly beneficial for developers of large-scale applications, such as server-based web applications that are accessible worldwide, because it allows them to rapidly localize the application for each region of interest.

To internationalize the architecture 110, developers employ a compilation and translation system that adapts locale-sensitive content to multiple other locales. Locale-sensitive content may include language, regional dialects, slang, cultural customs, and so on. Generally, during an offline procedure, the system compiles documents (e.g., web pages, email forms, UI screens, etc.) authored for one locale. The compilation procedure extracts locale-sensitive content into a separate data structure, leaving the locale-independent source code and other elements in the compiled document. The extracted content can then be translated for use in many other locales. During runtime, requests from different locales can be served locale-sensitive responses by retrieving the compiled document and dynamically populating it with the appropriate content for the locale to which the document is being served.

The compile and translate technique is quite different than the conventional solution for localizing applications, which involves brute force production of multiple versions of the same application for different locales. These separate versions are either developed independently or the entire application is translated by a translation service. The translation process requires in depth knowledge of both natural languages and web presentation technologies, such as HTML and JSP. As a result it is neither cost efficient nor very reliable. This replicating approach is also expensive when updating the application, as multiple versions of each change are required. The compilation procedure described herein minimizes the cost, improves efficiency, and enhances reliability of localizing applications.

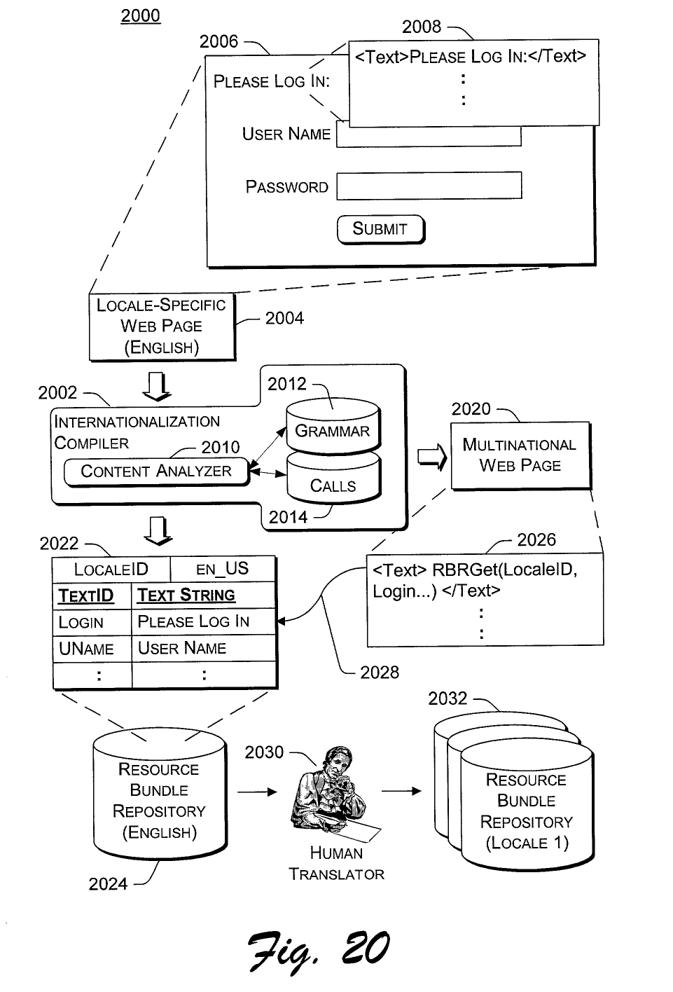

FIG. 20 illustrates the compilation and translation system 2000 that adapts servable content (e.g., documents, forms, web pages, UI screens, etc.) from one locale to one or more other locales. The compilation and translation system 2000 employs a tool, referred to as the “internationalization compiler” 2002, which reads documents (e.g., web pages, email forms, UI screens, etc.) of an application authored for one locale and automatically converts those documents into a form that can be easily localized to any other locale through the translation process. The compiler 2002 implements a set of rules that dictate how an input language (such as HTML, XML, WML, JSP, etc.) shall be localized. For example, a HTML rule defines which attribute value is localized (translated), and how the tag body, if defined, is localized (direct translation, treated as a script, etc.). The compiler 2002 is equipped with a parser (or more generally, a content analyzer) to parse the language(s) for the application. As an example, for a J2EE based application, the parser is able to parse HTML content (including JavaScript) and JSP pages.

The internalization compiler 2002 has a mechanism for extracting the locale-sensitive content, such as natural language elements, from the documents. This extracted content is tagged with a unique identifier, which can be used to later access the content. This identifier is inserted into the “compiled” document in place of the corresponding content, thereby creating a locale-independent document shell or core that contains locale-independent source code.

In the example illustrated in FIG. 20, suppose the document is a web page 2004 that is created for a specific locale, which utilizes English. When served and rendered, the web page 2004 forms a logon screen 2006 with English text. The logon screen 2006 contains an English textual greeting “Please Log In:”, an English textual element “User Name”, a first entry field to accept alphabet character strings for the user's name, an English textual element “Password”, and a second entry field to accept alphanumeric strings for the user's password. The logon screen 2006 also includes an actuatable “Submit” button.

For discussion purposes, suppose the web page 2004 is written in HTML. An excerpt of the HTML code for the login greeting is illustrated within a hovering box 2008. The login greeting is a textual element as delimited by the text tags “<Text>, </Text>”. The entire HTML source code for the visible elements of screen 2006 is presented below.

<Form>

<Text>Please Log In:</Text>

<input type=“text” name=“User Name” required=“true” maxlength=“32”>

<input type=“password” name=“Password” required=“true” minlength=“5”>

<input type=“submit” value=“Submit”>

</Form>

The locale-specific web page 2004 is submitted to the internationalization compiler 2002 for conversion to a locale-independent data structure. In the described implementation, the compiler 2002 extracts the locale-specific elements (e.g., language text, etc.) into a resource bundle and replaces the extracted elements in the web page with function calls to the resource bundle. The compiler 2002 includes a content analyzer 2010, a grammar 2012, and a call library 2014. The content analyzer 2010 analyzes each line of code in the locale-specific document (e.g., web page 2004) and identifies locale-specific elements. The content analyzer 2010 utilizes grammar 2012 to distinguish which elements are locale-specific by understanding the structure and form of the code. A grammar 2012 that specifies HTML, for example, aids the content analyzer 2010 in discerning which HTML tags contain text so that these tags can be flagged as containing character strings of a natural language that should be translated to another language. The content analyzer 2010 replaces the locale-specific elements with appropriate function calls retrieved from the call library 2014.

The content analyzer 2010 outputs a compiled data structure that is locale independent, as represented by the multinational web page 2020. The compiled data structure contains source code and locale-independent elements, but all natural languages or other locale-dependent content has been removed. The analyzer 2010 stores the extracted locale-specific content in a resource bundle 2022, which in turn is collected or stored in a repository 2024. In one implementation, the resource bundle 2022 is constructed as a property file, although other file types may be used (e.g., database file, etc.).

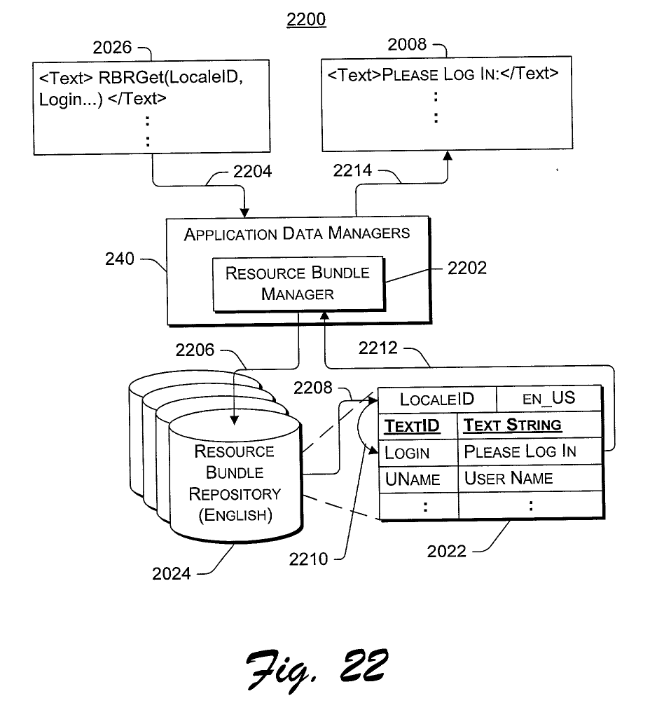

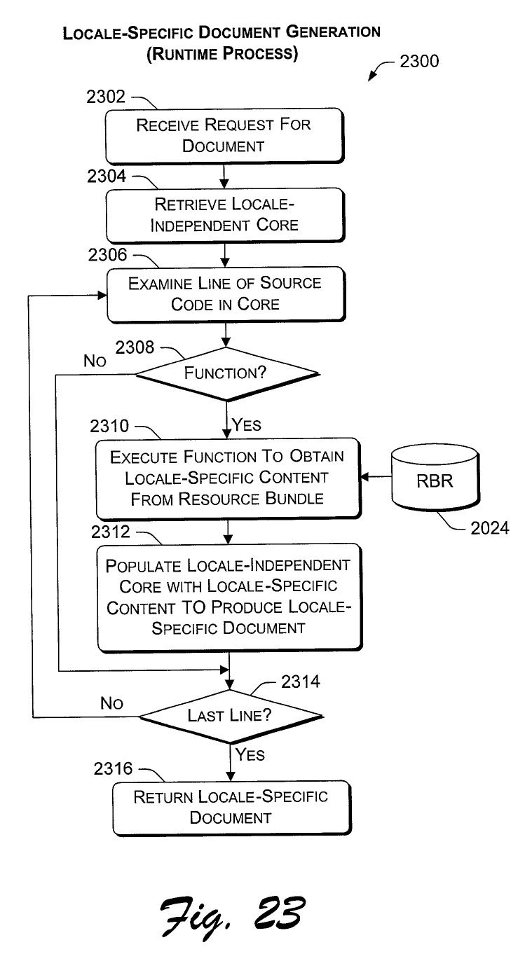

In the illustrated example of FIG. 20, the compiled web page 2020 contains tags and code elements of the original source code, as well as other locale-independent elements. The locale-specific content is replaced with the function calls to the appropriate resource bundle 2022. Notice that the HTML code 2026 for the multinational web page 2020 contains the same tags “<Text>, </Text>”, but the English text is replaced with a function call “RBRGet”. The function call has a set of parameters, including a locale identifier (e.g., “en_US”) to identify the corresponding resource bundle and a text string identifier (e.g., “Login”) to identify a desired text phrase to insert into the web page at runtime. When the web page 2020 is executed for a given locale, the function call is invoked to access the appropriate resource bundle 2022 to obtain the proper login greeting for that locale (as represented by reference arrow 2028). The runtime generation of a locale-specific web page 2020 is described below in more detail with reference to FIGS. 22 and 23.

The entire HTML source code for the compiled document core used to produce screen 2006 might appear like the following:

<Form>

<Text>RBRGet(LocaleID, Login, . . . )</Text>

<input type=“text” name=“RBRGet(LocaleID, Uname, . . . )” required=“true” maxlength=“32”>

<input type=“password” name=“RBRGet(LocaleID, PW, . . . )” required=“true” minlength=“5”>

<input type=“submit” value=“Submit”>

</Form>

The locale-specific content extracted from the logon screen and stored in resource bundle 2022 includes such elements as the English text strings “Please Log In”, “User Name”, and “Password”. The resource bundle 2022 is depicted as a tabular data structure with fields containing locale-specific content. A locale identifier “LocaleID” is set to a version of English named “en_US” to represent that the resource bundle contains elements for a locale that uses the version of English spoken and written in the United States, as opposed to the version of English spoken and written in the United Kingdom, or elsewhere.

To produce the same content for other locales, the resource bundle is translated by a human translator 2030 into the languages of the other locales. It is noted that automatic translation systems may be employed in addition to, or in place of, the human translators.

The translation process produces multiple resource bundles 2032 for different locales. Each resource bundle retains, however, the same identifiers so that the compiled document can locate the desired content. For example, the text identifier “Login” remains the same in the various resource bundles, even though the associated text string “Please Log In” is translated to the various languages. Each resource bundle is identified by the locale identity “LocaleID”.

Notice that by separating the content from the source code, the human translator 2030 only translates words and phrases, and does not need to understand the underlying source code such as HTML, XML, WML, and so on. The locale-independent core can be reused for different locales and languages. It does not need to be translated. When the core is processed, it simply pulls in content from various resource bundle repositories 2024 and 2032 to produce the content for associated locales.

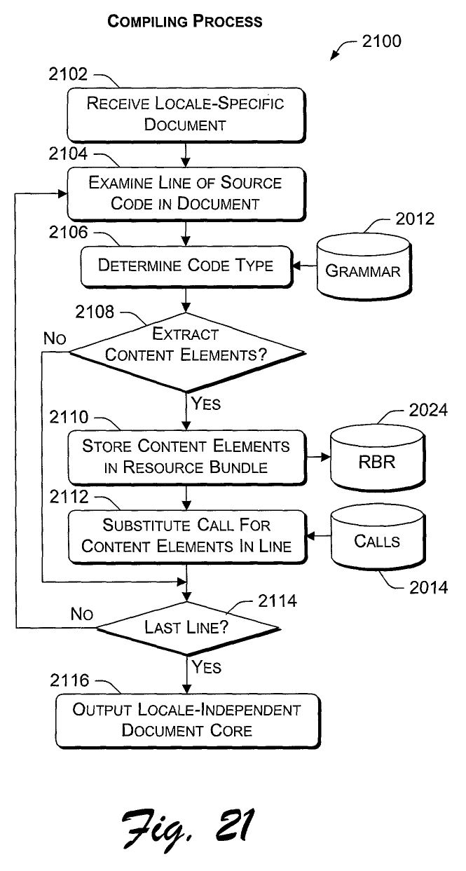

FIG. 21 shows a process 2100 for internationalizing content delivered by large-scale applications. The process 2100 is implemented as a software process performed by execution of software instructions and hence, the blocks illustrated in FIG. 21 recite acts performed when the computer-readable instructions are executed.

At block 2102, the compiler 2002 receives a locale-specific document, such as the HTML-based logon screen 2006 illustrated in FIG. 20. The compiler 2002 examines the source code in the document, line by line (i.e., block 2104). The compiler 2002 utilizes one or more grammars 2012 to determine the code type and whether such code type may have elements that are locale-specific (i.e., block 2106). For instance, the compiler 2002 can use a grammar versed in HTML to identify text tags “<Text>, </Text>”, while understanding that the content between the tags is locale specific and should be extracted.

At block 2108, the compiler 2002 decides whether to extract any locale-specific content elements from the source code line. This decision is based in part on the code type. If no such elements exist (i.e., the “no” branch from block 2108), the compiler continues to the next line of code. On the other hand, if locale-specific content elements exist (i.e., the “yes” branch from block 2108), the compiler extracts and stores the content elements in a resource bundle repository (RBR) 2024 (i.e., block 2110). The compiler then substitutes a function call from the call library 2014 for the content elements in the source code line (i.e., block 2112). The compiler 2002 continues, line-by-line, until the last line in the document is reached, as indicated by the decision block 2114.

Once the compiler has evaluated the entire document, it outputs the compiled document core with locale-independent source code and function calls substituted for locale-specific elements (i.e., block 2116). The resource bundle collected throughout the process is stored in repository 2024. After the resource bundle is created for a given locale, the resource bundle is translated into many different languages for many diverse locales, preserving the identifiers for each piece of translatable content. The resource bundle primarily includes the natural language content without any application code or formatting instructions (e.g., HTML and or JSP code). This makes translation easier and less error prone.

These resource bundles are accessible at runtime by the server application 110 to conform replies to the appropriate locales of the users. The server application implements a resource bundle manager to manage access to the various resource bundles. Given a locale identifier to locate the resource bundle and a content identity to find the locale-specific content within that bundle, the application can dynamically populate the compiled document with the content from the corresponding resource bundle at runtime.

FIG. 22 shows a runtime system 2200 that serves the appropriate content for a user's locale. The system 2200 includes a resource bundle manager 2202 that converts the locale-independent compiled document back into any appropriate locale-specific document by retrieving the correct locale-specific content from one of the resource bundles. The resource bundle manager 2202 is illustrated as being implemented as one of the application data managers 240 of the data coordination layer 206. However, it may reside in other layers of the multi-layer architecture 110 or external to the architecture. The resource bundle manager 2202 manages access to one or more resource bundle repositories 2024.

To illustrate the functionality of the resource bundle manager 2202, suppose that a user who is attempting to logon to the server application resides in a locale that speaks a United States version of English. The logic layer 204 (FIG. 2) receives the request and prepares to return a reply in the form of a login screen 2206 (FIG. 20). The logic layer 204 submits the identity of the locale and transfers control to the resource bundle manager 2202 of the resource coordination layer to obtain the appropriate login screen for that locale.

The resource bundle manager 2202 takes the locale-independent document 2026 produced by the internationalization compiler 2002 and executes the function calls in the source code (i.e., flow path 2204). In the illustrated example, the resource bundle manager 2202 executes the “RBRGet” function call, passing in parameters including a locale identity of “en_US” and a text identity of “Login”. The resource bundle manager 2202 uses the locale identity parameter to access the appropriate resource bundle repository that contains the resource bundle 2022 for “localeID=en_US” (i.e., flow paths 2206 and 2208). At this point, the text identity is used to index to the appropriate text string for “textID=Login” (i.e., flow path 2210). The English text string “Please Log In” is returned to the resource bundle manager 2202 (i.e., flow path 2212) and inserted into the document core, thereby producing the locale-specific document 2008 (i.e., flow path 2214).

FIG. 23 shows a process 2300 for producing at runtime locale-specific content delivered by large-scale applications. The process 2300 is implemented in software as computer-executable instructions that, when executed, perform the acts recited in the blocks of FIG. 23.

At block 2302, the resource bundle manager 2202 receives a request to produce a document (e.g., web document, email form, etc.) for a given locale. The request contains the identity of the locale (i.e., LocaleID) to specify the intended resource bundle and an identity of content (e.g., TextID) to identify the locale-specific content within the resource bundle.

At block 2304, the resource bundle manager 2202 obtains the locale-independent document core associated with the desired document. The resource bundle manager 2202 examines each line of source code in the document core (i.e., block 2306). If no function is found (i.e., the “no” branch from block 2308), the resource bundle manager continues to the next line of code.

When a function call is found in the source code (i.e., the “yes” branch from block 2308), the resource bundle manager 2202 executes the function call to access the appropriate resource bundle for the passed in locale identity and obtain the content specified by the content identity (i.e., block 2310). At block 2312, the resource bundle manager 2202 populates the locale-independent document core with locale-specific content to produce the desired document. The resource bundle manager 2202 continues, line-by-line, until the last line in the document is reached, as indicated by the decision block 2314. After all source code in the document core is examined (i.e., the “yes” branch from block 2314), the resource bundle manager 2202 returns the populated document to the logic layer for further processing, or to the presentation layer for presentation to the requesting client device (i.e., block 2316).

The compilation and translation process is beneficial in that it allows developers to develop an application in one language/country, and localize it for deployment anywhere in the world with minimum effort. The automatic extraction process employed by the compiler significantly reduces the time for bringing a new application to the world market. Also, by extracting out the natural language content, the translation process is simplified. The translators can concentrate exclusively on translating pure language content. No translation effort is required for any programming code or formatting instructions, making the translation phase more efficient and less error-prone. Furthermore, the translators do not even need to see the application since application development and translation are separate processes. This separation helps protects the proprietary information in the application.

For any future updates of the application, developers simply have to re-compile the locale-independent document cores. Any new content is appended to the existing resource bundle, making it is easy to find the new additions and have only those changes translated for other supported locales. In other words, only content that has been modified or added since the last compilation is translated, significantly reducing the cost and effort. Application development cost can be further reduced by sharing translation resource bundles across multiple applications.

Conclusion

The discussions herein are directed primarily to software modules and components. Alternatively, the systems and processes described herein can be implemented in other manners, such as firmware or hardware, or combinations of software, firmware, and hardware. By way of example, one or more Application Specific Integrated Circuits (ASICs) or Programmable Logic Devices (PLDs) could be configured to implement selected components or modules discussed herein.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A server system comprising:
one or more computers; and
a multi-layer application executing on the computers to handle client requests submitted by various client devices, the multi-layer application comprising:
a problem-solving logic layer to process the client requests according to an associated problem domain, the problem-solving logic layer containing one or more execution models to perform various sets of tasks when processing the client requests, the problem-solving logic layer producing replies to the client requests;
an execution environment layer to receive the client requests and select an appropriate execution model in the problem-solving logic layer for processing the client requests;
an interfacing layer to interface the problem-solving logic layer with one or more resources so that the execution models may utilize the resources when processing the client requests; and
a presentation layer to receive the replies produced by the problem-solving logic layer and to structure the replies in a manner that makes the replies presentable on the various client devices.

2. A server system as recited in claim 1, wherein the execution environment layer comprises a framework to receive the client requests and route the requests to the problem-solving logic for processing.

3. A server system as recited in claim 2, wherein the execution environment layer comprises one or more adapters to interface the framework with different types of the client devices.

4. A server system as recited in claim 1, wherein the execution environment layer comprises:
a model dispatcher to route the client requests to selected execution models in the problem-solving logic layer; and
a request dispatcher to structure the replies for return to the client devices.

5. A server system as recited in claim 1, wherein the multi-layer application can be adapted to receive requests from new client devices with incompatible communication protocols by substituting a new execution environment layer that supports the new client devices.

6. A server system as recited in claim 1, wherein one of the execution models is embodied as a set of discrete program modules, each program module performing a specific task.

7. A server system as recited in claim 1, wherein one of the execution models is embodied as an interaction-based model in which computer programs are defined by a series of interaction definitions.

8. A server system as recited in claim 1, wherein the execution models are embodied according to at least one of a command model, an action-view model, and a use case model.

9. A server system as recited in claim 1, wherein one of the execution models performs tasks according to a first business purpose, and the multi-layer application being reconfigurable to achieve a different business purpose by installing another execution model that performs tasks according to the second business purpose.

10. A server system as recited in claim 1, wherein the interfacing layer comprises:
a data abstraction layer to obtain data from the resources and map the data into a domain framework that models information flow for a specific problem domain; and
a data coordination layer that provides an interface for the problem-solving logic layer to access the domain framework of the data abstraction layer and obtain the data.

11. A server system as recited in claim 10, wherein the data coordination layer comprises one or more application data managers that interface the domain framework in the data abstraction layer into an application solution space of the problem-solving logic layer.

12. A server system as recited in claim 1, wherein the multi-layer application can be adapted to access new resources by substituting in a new interfacing layer that supports the new resources.

13. A server system as recited in claim 1, wherein the client devices support different data formats, the presentation layer being configured to select appropriate data formats for encoding the replies.

14. A server system as recited in claim 1, wherein the client devices support different communication protocols, the presentation layer being configured to select appropriate communication protocols for delivering the replies to the clients.

15. A server system as recited in claim 1, wherein the presentation layer is configured to determine how to display the replies for a particular client.

16. A server system as recited in claim 1, wherein the presentation tier is configured to determine at least one of (1) a layout of individual replies, (2) display attributes in which to present the replies, and (3) a presentation theme.

17. A server system as recited in claim 1, wherein the presentation layer comprises:
a presentation module to determine how the replies will appear on the client devices to users; and
a rendering module, separate from the presentation module, to determine how to render the replies on the client devices.

18. A server system as recited in claim 1, further comprising an authentication module to authenticate the client devices or users of the client devices.

19. A server system as recited in claim 1, further comprising a constraint system to constrain operation of the multi-layer application according to a hierarchy of different constraints.

20. A server system as recited in claim 1, further comprising a constraint system to constrain operation of the multi-layer application according to multiple different constraints, the constraint system comprising a hierarchy of constraint layers, with each constraint layer containing a set of one or more constraints that customize operation of the multi-layer application.

21. A server system as recited in claim 1, further comprising:
a constraint hierarchy of multiple constraint layers, each constraint layer containing a set of one or more constraints that constrain operation of the multi-layer application, the constraint layers being organized within the constraint hierarchy such that a first constraint layer limits a second constraint layer but the second constraint layer does not limit the first constraint layer; and
a constraint resolver to resolve the constraint layers so that operation of the multi-layer application is constrained by a set of the constraints in the constraint layers.

22. A server system as recited in claim 21, wherein the hierarchy of constraints comprises constraints selected from a group of constraints comprising:
legally mandated constraints to constrain operation of the multi-layer application according to legal principles;
company-mandated constraints to constrain operation of the multi-layer application according to preferences of a company that operates the application;
customer constraints to constrain operation of the multi-layer application according to preferences of customers;
cultural constraints to constrain operation of the multi-layer application according to cultural aspects; and
end user constraints to constrain operation of the multi-layer application according to preferences of an end user.

23. A server system as recited in claim 1, further comprising a security policy enforcement module to enforce security restrictions on accessing information stored at the one or more resources.

24. A server system as recited in claim 23, wherein the security policy enforcement module is to enforce the security restrictions based on a set of low-level security rules defined using high-level permission concepts.

25. A server system as recited in claim 1, wherein the presentation layer includes a form processor to generate a data input form for the multi-layer application by automatically adding, to a form definition that defines the data input form, validation code to validate subsequent inputs to one or more fields of the data input form.

26. A server system as recited in claim 25, wherein the form processor is to generate the data input form by identifying one or more custom tags associated with the data input form, to replace each of the one or more custom tags with another tag, and further to add to the form definition, for each of the one or more replaced tags, validation code to validate subsequent inputs to a field corresponding to the tag.

27. A server system as recited in claim 25, wherein the form processor is further to automatically identify one or more data input fields to be included in the form definition.

28. A server system as recited in claim 25, wherein the form processor is further to automatically identify one or more restrictions associated with a data input field of the data input form, and to determine the validation code based at least in part on the one or more restrictions.

29. A server system as recited in claim 1, further comprising:
a resource bundle containing locale-specific content that is authored for a particular locale; and
a resource bundle manager to populate a locale-independent core with the locale-sensitive content in the resource bundle to produce a computer-servable document that can be served by the multi-layer application to the particular locale.

30. A server system as recited in claim 29, wherein the resource bundle manager resides in the interfacing layer.

31. A business-oriented computer software architecture stored on one or more computer-readable media, comprising:
a framework module to receive client requests from different client devices;
a first business logic module to process the client requests received by the framework according to an associated business purpose, the first business logic module generating replies corresponding to the client requests;
a presentation module to structure the replies produced by the first business logic module in a manner that makes the replies presentable on the client devices; and
the business-oriented computer software architecture being reconfigurable to another business purpose by substituting a second business logic module for the first business logic module.

32. A business-oriented computer software architecture as recited in claim 31, wherein the framework module forms a container for the first and second business logic modules that allows the first and second business logic modules to be selectively added or removed from the architecture.

33. A business-oriented computer software architecture as recited in claim 31, wherein the first and second business logic modules are implemented as discrete programs, each program performing a specific task.

34. A business-oriented computer software architecture as recited in claim 31, wherein the client devices support different data formats, the presentation layer being configured to select appropriate data formats for encoding the replies.

35. A business-oriented computer software architecture as recited in claim 31, wherein the client devices support different communication protocols, the presentation layer being configured to select appropriate communication protocols for delivering the replies to the clients.

36. A business-oriented computer software architecture as recited in claim 31, wherein the presentation module comprises:
a presentation component to structure how the replies will appear; and
a rendering component, separate from the presentation component, to configure how the replies are output on a particular client.

37. A business-oriented computer software architecture as recited in claim 31, wherein the presentation module generates a data input form by automatically adding, to a form definition that defines the data input form, validation code to validate subsequent inputs to one or more fields of the data input form.

38. A business-oriented computer software architecture as recited in claim 37, wherein the presentation module automatically identifies one or more data input fields to be included in the form definition.

39. A business-oriented computer software architecture as recited in claim 37, wherein the presentation module automatically identifies one or more restrictions associated with a data input field of the data input form and determines the validation code based at least in part on the one or more restrictions.

40. A business-oriented computer software architecture as recited in claim 31, further comprising a domain framework to model information flow for a particular business domain.

41. A business-oriented computer software architecture as recited in claim 31, further comprising a constraint hierarchy with a hierarchical set of constraints that specify how the replies should be structured to customize the replies.

42. A business-oriented computer software architecture as recited in claim 31, further comprising:
a resource bundle containing locale-specific content that is authored for a particular locale; and
a resource bundle manager to populate a locale-independent core with the locale-sensitive content in the resource bundle to produce the replies.

43. A business-oriented computer software architecture stored on one or more computer-readable media, comprising:
a first layer to obtain data from external resources and map the data into a domain framework that models information flow for a specific problem domain;
a second layer to provide an interface into the domain framework of the first layer;
a third layer to process requests and produce replies, the third layer utilizing the second layer to access the domain framework and retrieve the data obtained by the first layer from the external resources;
a fourth layer to structure the replies for presentation and rendering on diverse client devices; and
wherein anyone of the first layer, the second layer, the third layer, and the fourth layer may be changed independently of other layers to modify operation of the computer software architecture.

44. A business-oriented computer software architecture as recited in claim 43, wherein the first layer may be updated to obtain data from new external resources.

45. A business-oriented computer software architecture as recited in claim 43, wherein the third layer is an original third layer that processes the requests according to a first business domain, further comprising a new third layer substituted for the original third layer to process the requests according to a second business domain.

46. A business-oriented computer software architecture as recited in claim 43, wherein the fourth layer can be updated to structure the replies for new client devices.

47. A business-oriented computer software architecture as recited in claim 43, wherein the fourth layer can be modified to structure the replies for presentation to users in different regions of the world.

48. A method comprising:
receiving requests from multiple clients, the requests being related to a problem domain;
processing the requests within problem-solving logic to produce replies within the problem domain, the processing comprising requesting data to be used in formulating the replies;
retrieving the data from one or more external resources and mapping the data to a domain framework for the problem domain, the domain framework being independent from the problem-solving logic; and
interfacing the problem-solving logic to the domain framework to obtain the data for use in processing the request.

49. A method as recited in claim 48, further comprising structuring the replies for presentation to the clients.

50. A method as recited in claim 48, further comprising:
structuring the replies to define how the replies will appear when presented at the clients; and
independent of said structuring, conforming the replies to output capabilities of the clients.

51. A method as recited in claim 48, further comprising constraining how the replies are presented according to a hierarchy of constraints, wherein the hierarchy of constraints comprises multiple constraints such that a first constraint limits a second constraint but the second constraint does not limit the first constraint.

52. A method for creating server applications for multiple different problem domains, comprising:
providing a framework to receive client requests from multiple different clients, individual clients communicating messages using different protocols and formats;
providing a resource structure to access resources that provide data related to the different problem domains;
creating a first server application for a first problem domain by interfacing first domain logic with the framework and the resource structure, the first domain logic being configured to process the client requests for the first problem domain;
creating a second server application for a second problem domain by interfacing second domain logic with the framework and the resource structure, the second domain logic being configured to process the client requests for the second problem domain; and
the first and second domain logic producing replies that the framework returns to the clients using the protocols and messaging formats employed by the clients.

53. A method as recited in claim 52, wherein the providing a resource structure comprises providing a resource structure that retrieves data from one or more external resources and maps the data to a domain framework that models information flow for a specific problem domain.

54. A method as recited in claim 52, further comprising:
structuring the replies to define how the replies will appear when presented at the clients; and
independent of said structuring, conforming the replies to output capabilities of the clients.

55. A method as recited in claim 52, further comprising generating a data input form for service to a client by automatically adding, to a form definition that defines the data input form, validation code to validate subsequent inputs to one or more fields of the data input form.

56. A method as recited in claim 52, further comprising automatically identifying one or more data input fields to be included in a data input form based on the first and second domain logic.

57. A method as recited in claim 52, further comprising forming a reply for a particular locale by retrieving a locale-independent core that contains locale-independent elements and populating the locale-independent core with locale-sensitive content that is appropriate for the particular locale.
